(19) United States
(12) Patent Application Publication
(10) Pub. No.: US 2013/0318082 A1
(43) Pub. Date: Nov. 28, 2013

(54) GENERATION APPARATUS, GENERATION METHOD, SEARCHING APPARATUS, AND SEARCHING METHOD

(71) Applicant: FUJITSU LIMITED, Kawasaki-shi (JP)

(72) Inventors: Masahiro KATAOKA, Tama (JP); Takafumi OHTA, Chuo (JP); Takahiro MURATA, Yokohama (JP)

(73) Assignee: FUJITSU LIMITED, Kawasaki-shi (JP)

(21) Appl. No.: 13/855,215

(22) Filed: Apr. 2, 2013

(30) Foreign Application Priority Data
May 24, 2012 (JP) 2012-119096

(51) Int. Cl. G06F 17/30

(52) U.S. Cl. CPC G06F 17/30424; G06F 17/30595
USPC 707/736; 707/769

(57) ABSTRACT

A generation apparatus includes a processor configured to generate existence information indicating that character information including a plurality of continuing characters is included in the file, and in a case that first adscript designation and second adscript designation following to the first adscript designation are included in the file, the first adscript designation designating that first character information is written down with second character information, the second adscript designation designating that third character information is written down with fourth character information, generate another existence information indicating that another character information, which includes an end part of the first character information and a head part of the fourth character information following the end part, is included in the file.

### CROSS-REFERENCE TO RELATED APPLICATION

This application is based upon and claims the benefit of priority of the prior Japanese Patent Application No. 2012-119096, filed on May 24, 2012, the entire contents of which are incorporated herein by reference.

### FIELD

The embodiment discussed herein is related to data search technology.

### BACKGROUND

Regarding full-text search and index search of an electronic book, an electronic dictionary, and the like, such technique has been disclosed that search object files are narrowed down by using index information which indicates an association relationship indicating which file in a file group includes character information of a search string. For example, in a case where certain character information C is included in a search string, a file which is indicated, in preliminarily-generated index information, such that the file includes character information C is set as a search object of character string search based on the search string. On the other hand, it is apparent that a file of which inclusion of the above-mentioned character information C is not indicated in the index information does not include the search string, even without performing character string search. Therefore, a file of which inclusion of the character information C is not indicated in the index information is excluded from objects of the character string search.

Examples of index information include index information which indicates which file in a file group includes character information on the basis of a value of each bit which is assigned with respect to each file. In the index information, a bit column in which bits are aligned in an order of file numbers corresponds to each piece of character information. In a file of which a file number corresponds to a bit having a value “1” in a bit column, character information corresponding to the bit column exists. On the other hand, in an object file of which a file number corresponds to a bit having a value “0”, character information corresponding to the bit column does not exist.

Further, there is a case where index information includes a bit column indicating which file includes character information including a plurality of characters. Character information including a plurality of characters is ““a” “b””, ““tana” “bata””, ““bata” “matsu””, ““matsu” “ri”” (each of “tana”, “bata”, and “matsu” expresses one Chinese character corresponding to one character code and “ri” expresses one Hiragana character corresponding to one character code in the original specification), and the like, for example, in a case of character information for two characters. In a case where there is a file F including a word “about”, a bit, which corresponds to the file F, in a bit column which corresponds to character information such as “ab” and “bo” is set to “1”. Further, in a case where the file F includes a word ““tana” “bata” “matsu” “ri””, a bit, which corresponds to the file F, in a bit column which corresponds to each of ““tana” “bata””, ““bata” “matsu””, and ““matsu” “ri”” is set to “1”.

For example, in a case where search of a file group is performed by using a search string which is ““tana” “bata” “matsu” “ri””, a corresponding part of index information is referred for each piece of character information ““tana” “bata””, ““bata” “matsu””, and ““matsu” “ri”” that are included in the search string ““tana” “bata” “matsu” “ri””. As a result of the reference, character string search using the search string ““tana” “bata” “matsu” “ri”” is performed with respect to a file which is indicated in index information such that the file includes all of ““tana” “bata””, ““bata” “matsu””, and ““matsu” “ri”” (a bit corresponding to each of ““tana” “bata””, ““bata” “matsu””, and ““matsu” “ri”” is set to “1”).

In markup languages such as html, modification information of text (designation of the size of characters, a state of composition, and the like) is designated by using a tag which is expressed by a text or the like. Examples of modification based on modification information include such modification that a language unit having one meaning (a unit constituting a language, such as a word and a character) is written with character information in a plurality of different notations (for example, a notation of a character string provided with reading, a notation of Chinese provided with pinyin and the like). In a text written by a markup language, a notation (display rules such as a display position and a display size) is designated by a tag. For example, in a case where a ruby annotation is provided to a character string, whether to be notation designated for a reading character or notation designated for a character to which reading is to be provided (parent character) is discriminated by a tag. Based on the tag designating the ruby annotation, the parent character and the reading character (or the notation) are provided in adscript form. In other words, the parent character is written down with the reading character. In a html file, a part corresponding to character information ““tana” “bata” “matsu” “ri”” in a file F is expressed by a description (description D1) such as “<ruby> <rb>“tana” “bata”</rb> <rp>(</rp> <rt>“ta” “na” “ba” “ta” “/rt> <rp>)</rp> <rb>“matsu”</rb> <rp>(</rp> <rt>“ma” “tsu”</rt> <rp>)</rp> </ruby>“ri””, for example. In the case of the description D1, ““tana” “bata”” are parent characters and ““ta” “na” “ba” “ta”” (each of “ta”, “na”, “ba”, and “ta” expresses one Hiragana character in the original specification) are reading characters. By designating reading by such expression, a plurality of different notations (““tana” “bata”” and ““ta” “na” “ba” “ta””, ““matsu” “ri”” and ““ma” “tsu” “ri””) are displayed together.

The description D1 is ““tana” “bata” . . . “ta” “na” “ba” “ta” . . . “matsu” . . . “ma” “tsu” . . . “ri”” when tag information is excluded. For example, when index information corresponding to every piece of two-character information is generated without including tag information, a bit corresponding to the file F is set to “1” with respect to each of ““tana” “bata””, ““bata” “ta””, ““ta” “na”, “na” “ba””, ““ba” “ta””, ““ta”, “matsu””, ““matsu” “ma””, ““ma” “tsu””, and ““tsu” “ri””. However, due to existence of modification information, the description D1 does not include character information such as ““bata” “matsu””. Therefore, such possibility arises that a file including the above-mentioned text is not extracted as a search object of a search string such as ““tana” “bata” “matsu” “ri””.

In character string search, such technique has been disclosed that information for discriminating a character string with no reading, a parent character, and a reading character is associated with each piece of character information (except for a tag), so as to collate the search string only with a character which is associated with discrimination information which is same as a character according with a head character of the search string. When the head of the search string and a parent character are accorded with each other in the collation processing, collation with reading characters existing up to a following parent character is skipped and collation with the character information following the skipped reading characters is performed.

In the description D1, a parent character and a reading character are provided together as ““tana” “bata”” and ““ta” “na” “ba” “ta””, so that displayed character information includes a series of ““ta” “na” “ba” “ta”” and ““matsu” “ri”” and a series of ““tana” “bata”” and ““ma” “tsu” “ri””. However, a text ““tana” “bata” . . . “ta” “na” “ba” “ta” . . . “matsu” . . . “ma” “tsu” . . . “ri”” obtained by excluding tag information from the description D1 of the file F does not include ““ta” “matsu”” and ““bata” “ma””. Therefore, even if a part of description which includes designation of reading (““ta” “na” “ba” “ta”” and ““ma” “tsu”” or ““tana” “bata”” and “matsu”) is skipped in generation of index information, the file F is not selected as a search object when a search string is ““ta” “na” “ba” “ta” “matsu” “ri”” or ““tana” “bata” “ma” “tsu” “ri””.

For example, Japanese Laid-open Patent Publication No. 2003-330917, Japanese Laid-open Patent Publication No. 2011-138230, International Publication Pamphlet No. W02006/123429 and International Publication Pamphlet No. 2008/090606 have been issued.

### SUMMARY

According to an aspect of the invention, a generation apparatus includes a processor configured to generate existence information indicating that character information including a plurality of continuing characters is included in the file, and in a case that first adscript designation and second adscript designation following to the first adscript designation are included in the file, the first adscript designation designating that first character information is written down with second character information, the second adscript designation designating that third character information is written down with fourth character information, generate another existence information indicating that another character information, which includes an end part of the first character information and a head part of the fourth character information following the end part, is included in the file.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A illustrates examples of index information and a bit column which is generated on the basis of the index information;

FIG. 1B illustrates examples of index information and a bit column which is generated on the basis of the index information;

FIG. 2 illustrates an example of a function block of a computer;

FIG. 3 illustrates an example of a function block of a generation unit;

FIG. 4 illustrates an association relationship between a file number and a file path;

FIG. 5 illustrates an example of a function block of a narrow-down unit;

FIG. 6A illustrates an example of an automaton which is used for index generation;

FIG. 6B illustrates an example of an automaton which is used for index generation;

FIG. 6C illustrates an example of an automaton which is used for index generation;

FIG. 7A illustrates determination processing using an automaton;

FIG. 7B illustrates determination processing using an automaton;

FIG. 7C illustrates determination processing using an automaton;

FIG. 8 illustrates an example of the hardware configuration of the computer;

FIG. 9 illustrates a configuration example of software which is operated in the computer;

FIG. 10 illustrates a processing procedure example of index generation;

FIG. 11 illustrates a processing procedure example of search processing;

FIG. 12 illustrates a processing procedure example of index reference;

FIG. 13 illustrates an example of a list indicating a part according with a search string;

FIG. 14A illustrates an example of a determination processing procedure of whether or not character information is included in a file;

FIG. 14B illustrates an example of the determination processing procedure of whether or not character information is included in a file;

FIG. 15A illustrates extraction processing for extracting character information which is included in a file;

FIG. 15B illustrates extraction processing for extracting character information which is included in a file;

FIG. 15C illustrates extraction processing for extracting character information which is included in a file;

FIG. 16A illustrates an example of automatons which are used in index generation;

FIG. 16B illustrates an example of automatons which are used in index generation;

FIG. 17A illustrates determination processing using an automaton;

FIG. 17B illustrates determination processing using an automaton;

FIG. 18 illustrates determination processing using an automaton;

FIG. 19 illustrates a data configuration example of an automaton; and

FIG. 20 illustrates an example of a generation procedure of an automaton.

### DESCRIPTION OF EMBODIMENTS

Narrowing down of search object files performed by using index information is first described.

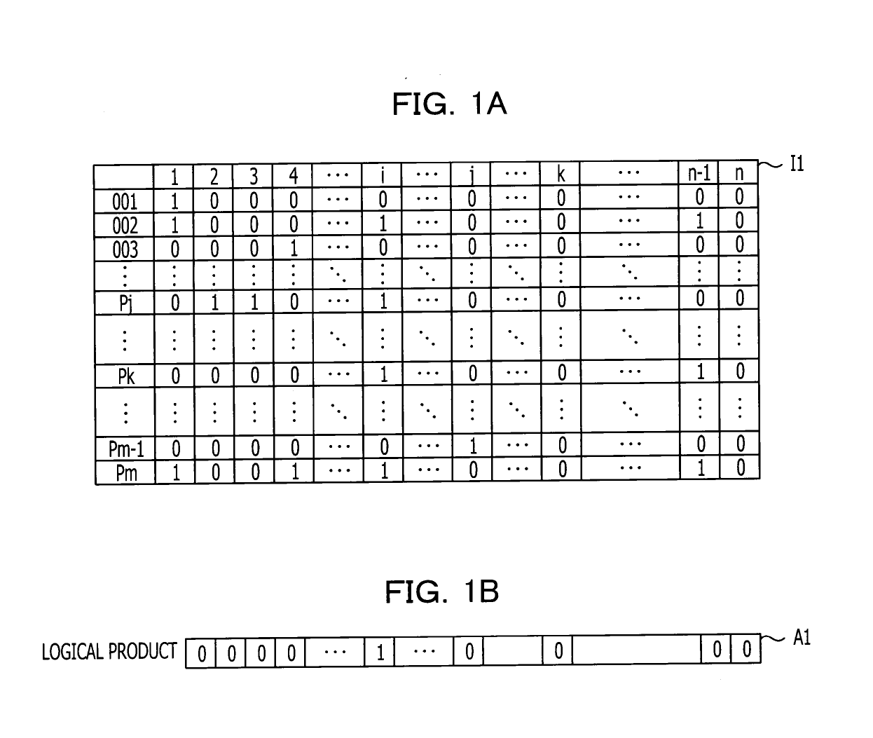

FIG. 1A illustrates index information I1 based on a group of files F1 to Fn which are search objects. The highest row in the index information I1 which is depicted in FIG. 1A indicates a file number. The file number corresponds to each file of the group of files F1 to Fn which are the search objects. In the index information I1, each piece of character information of a group of character information C1 to Cm corresponds to a bit column related to existence/nonexistence of character information in each file of the group of files F1 to Fn.

Character information Cj included in the group of character information C1 to Cm is a character string which is composed of one character or a combination of a plurality of characters, for example. Alternatively, character information Cj may be a part of a binary code corresponding to the character information. For example, the group of character information C1 to Cm includes all patterns of combinations in which predetermined number of characters from a character whose use is assumed (for example, a character to which a JIS code is assigned) are combined. Further, the group of character information C1 to Cm includes a basic word of high frequency in use, for example.

For example, it is assumed that a certain file F1 (the file number is i) of the group of files F1 to Fn includes a character string ““tana” “bata” “matsu” “ri””. In this case, the file Fi includes pieces of character information which are “tana”, “bata”, “matsu”, and “ri” and also includes pieces of character information which are ““tana” “bata””, ““bata” “matsu””, and ““matsu” “ri””. In this embodiment, a case where each piece of character information of the group of character information C1 to Cm is character information for two characters is illustrated.

Information related to whether or not the character information Cj is included in a file Fi is stored in a storage region corresponding to the character information Cj and the file Fi, for each number i of numbers 1 to n, thus indicating which file includes the character information Cj among files of the group of files F1 to Fn. For example, in the index information I1, an address of a storage destination of existence/nonexistence information which is related to whether or not the character information Cj is included in the file Fi is represented by an address Pj, which is obtained by substituting a binary code corresponding to the character information Cj into a hash function, and a file number i. For example, a binary code (character code based on JIS) corresponding to character information ““tana” “bata”” is 0x3C374D2C (0x denotes hexadecimal notation). Further, a binary code of ““tana” “bata”” is 0x4EO35915 in UTF-16.

In a case where one address Pj is assigned for one piece of character information Cj, existence/nonexistence information of the character information Cj is expressed as following. When the character information Cj exists in the file Fi, the existence/nonexistence information is expressed by a bit having a value of “1”. When the character information Cj does not exist in the file Fi, the existence/nonexistence information is expressed by a bit having a value of “0”. There is also a case where a plurality of pieces of character information (for example, character information Cj and character information Ck) are assigned for one address Pj. In such case, existence/nonexistence information is expressed by a bit having a value of “1” when at least one of the character information Cj and the character information Ck exists in the file Fi, and the existence/nonexistence information is expressed by a bit having a value of “0” when neither the character information Cj nor the character information Ck exists in the file Fi. Here, expression of existence/nonexistence information may be arbitrarily changed. Nonexistence may be expressed by a bit having a value of “1” and existence may be expressed by a bit having a value of “0”. Further, existence/nonexistence may be expressed by a plurality of bits. In the index information depicted in FIG. 1A, inclusion of character information is expressed by a bit having a value of “1”.

When character information corresponding to an address Pj is only ““tana” “bata””, for example, it becomes apparent that ““tana” “bata”” is included in each of files of file numbers 2, 3, and i, from a bit column expressed in the address Pj of the index information IL Further, when only ““bata” “matsu”” corresponds to one address Pk, for example, a bit column expressed in the address Pk of the index information I1 represents whether or not each file of the group of files F1 to Fn includes ““bata” “matsu””. For example, it is represented that files of file numbers i and n-1 include ““bata” “matsu”” and files of file numbers 1, 2, 3, j, k, and the like do not include ““bata” “matsu””.

As depicted in FIG. 1A, the file Fi includes character information other than ““tana” “bata””, as well, so that bits on positions corresponding to not only character information ““tana” “bata”” but also other pieces of character information such as ““bata” “matsu””, ““matsu” “ri””, and so on have a value of “1”. Further, regarding the group of files F1 to Fn, a bit on a position corresponding to character information which is included in each file has a value of “1”, though depiction thereof is omitted in FIG. 1A.

When search is performed with respect to the group of files F1 to Fn, files to be search objects of character string search are narrowed down by using the index information I1 depicted in FIG. 1A. For example, it is assumed that a search request including a search string ““tana” “bata” “matsu”” is received. The search string ““tana” “bata” “matsu”” includes character information ““tana” “bata”” and character information ““bata” “matsu””. In this case, files to be objects of the character string search are narrowed down on the basis of a bit column expressed in an address (Pj in FIG. 1A) which is calculated on the basis of ““tana” “bata”” and a bit column expressed in an address (Pk in FIG. 1A) which is calculated on the basis of ““bata” “matsu””, for example. A bit column A1 which is a result of a logical AND operation between the bit column corresponding to the address Pj and the bit column corresponding to the address Pk is expressed as FIG. 1B, for example.

In the bit column A1 depicted in FIG. 1B, a file corresponding to a bit having a value “1” (a file of a file number i, in FIG. 1B) is a file to be an object of the character string search. Files corresponding to bits having a value “0” in the bit column A1 which is calculated on the basis of the index information I1, that is, files which obviously do not include at least one of the character information ““tana” “bata”” and ““bata” “matsu”” are excluded from search objects.

The same goes for a case using a half-size character. For example, it is assumed that a file Fi includes a character string “BIOS (BASIC INPUT/OUTPUT SYSTEM)”. For example, in the index information I1, a bit on a position which is expressed on an address Pj which is calculated on the basis of character information “INPU” and a file number i has a value of “1”. Further, for example, a bit on a position which is expressed on an address Pk which is calculated on the basis of character information “OUTP” and a file number i has a value of “1”. When the search string is “INPUT/OUTPUT”, bit columns respectively corresponding to “INPU” and “OUTP” are acquired from the index information I1 and a bit column A1 (refer to FIG. 1B) is calculated by a logical AND of the respective bit columns, for example. Files which obviously do not include at least one of “INPU” and “OUTP” (files having a value “0” in bit columns) are excluded from search objects on the basis of the bit column Al.

As described above, a markup language such as hypertext markup language (html) includes such modification that a word or a character having one meaning is written with character information of a plurality of different notations (for example, display of a character string provided with reading, display of Chinese provided with pinyin, and the like), for example. When such modification is used, a plurality of pieces of character information which are different notations of the same word are provided in series in document data. For example, character information following ““tana” “bata”” is ““matsu” “ri”” or ““ma” “tsu” “ri”” normally. However, the description D1 using a markup language is ““tana” “bata” . . . “ta” “na” “ba” “ta” . . . “matsu” . . . “ma” “tsu” . . . “ri””, so that character information following ““tana” “bata”” is ““ta” “na” “ba” “ta””. As a result, in the index information I1, a bit corresponding to ““bata” “matsu”” and a bit corresponding to ““bata” “ma”” with respect to the file Fi including the description of ““tana” “bata” . . . “ta” “na” “ba” “ta” . . . “matsu” . . . “ma” “tsu” . . . “ri”” have a value of “0”. Therefore, when files are narrowed down on the basis of the search string such as ““tana” “bata” “matsu” “ri”” or ““tana” “bata” “ma” “tsu” “ri””, for example, it is determined that neither ““bata” “matsu”” nor ““bata” “ma”” is included. Accordingly, the file Fi is excluded from objects of the character string search in both cases of search strings ““tana” “bata” “matsu” “ri”” and ““tana” “bata” “ma” “tsu” “ri””. In display according to the file Fi, it is determined that none of a combination of ““tana” “bata”” and ““matsu” “ri””, a combination of ““ta” “na” “ba” “ta”” and ““matsu” “ri””, and a combination of ““tana” “bata”” and ““ma” “tsu” “ri”” is included in the file Fi even though these combinations are continuing character information. Contrarily, regarding character information such as ““bata” “ta”” and ““matsu” “ma””, it is determined that pieces of character information which are not continued when displayed in accordance with designation by tag information continuingly exist in the file Fi.

Display with provision of a plurality of different notations is employed not only in Japanese documents but also in Chinese documents and English documents. In English, reading is provided with respect to an abbreviation, for example.

There is a case where reading such as “BASICINPUT/OUTPUTSYSTEM” is provided with respect to an abbreviation “BIOS”. In this case, the file Fi includes a description D2 such as “<ruby> <rb>B</rb> <rp>(</rp> <rt>BASIC</rt> <rp>)</rp> <rb>I</rb> <rp>(</rp> <rt>INPUT/</rt> <rp>)</rp> <rb>O</rb> <rp>(</rp> <rt>OUTPUT</rt > <rp>)</rp> <rb>S</rb> <rp>(</rp> <rt>SYSTEM</rt> <rp>)</rp> </ruby>”. In this case as well, “BBASICIINPUT/OOUTPUTSSYSTEM” is obtained merely by excluding tags, as is the case with Japanese. It is determined that a plurality of pieces of character information which do not exist in series when being displayed in accordance with designation by tag information exist in series in the file Fi, while a plurality of pieces of character information which exist in series when being displayed in accordance with the designation by tag information do not exist in series in the file Fi, disadvantageously.

When index information indicating whether or not character information exists in each file regarding every piece of character information for four English characters is generated on the basis of “BBASICIINPUT/OOUTPUTSSYSTEM”, it is indicated that pieces of character information such as “INPU”, “PUT/”, and “TPUT” are included. However, it is determined that character information such as “CIOS” and “IOSY” is not included in the description D2, while it is determined that character information “SSYS” is included in the description D2. For example, when the search string is “BASICIOSYSTEM”, it is determined that “CIOS” and “IOSY” are not included in the description D2, bringing a possibility that the file Fi is excluded from objects of the character string search. Further, there is a case where not only “BBASICIINPUT/OOUTPUTSSYSTEM” (including “SSYS”) but also “STOLE (including “STOL” and “TOLE”)”, “ODYSSEY (including “DYSS”)”, and the like are included together in the file Fi. For example, when the search character string is “DYSSYSTOLE”, there is a possibility that the file Fi is selected as an object of the character string search because the file Fi includes “DYSS”, “SSYS”, “STOL”, and “TOLE” even if the file Fi does not include “DYSSYSTOLE”.

It is assumed that a file Fi included in a group of files F1 to Fn includes designation of a plurality of notations (a notation W1 and a notation W2) of a word V1 and designation of provision of both of the notation W1 and the notation W2 of the word V1 that follow the word V1. Applied to the above-described example, the notation W1 is a parent character to which reading is provided and the notation W2 is a reading character. Further, the word V1 is ““tana” “bata””, for example. The word V1 is written as ““tana” “bata”” in character information CR1 of the notation W1 and is written as ““ta” “na” “ba” “ta”” in character information CR2 of the notation W2. Further, a word V2 is “matsu”, for example. The word V2 is written as “matsu” in character information CR3 of the notation W1 and is written as ““ma” “tsu”” in character information CR4 of the notation W2.

In the embodiment, a procedure to extract from the file Fi both of [1] character information in which a head part of character information CR3 follows an end part of character information CR1 and [2] character information in which a head part of character information CR2 follows the end part of the character information CR1 is executed. Further, in the embodiment, neither [3] character information in which the head part of the character information CR2 follows after the end part of the character information CR1 nor [4] character information in which a head part of character information CR4 follows after an end part of the character information CR3 is extracted. Further, a procedure to set a bit, which corresponds to the file Fi, in a bit column corresponding to extracted character information to “1” in index information is executed. Further, processing to narrow down files, which are to be search objects, by using index information which is generated through the above-described procedure is performed.

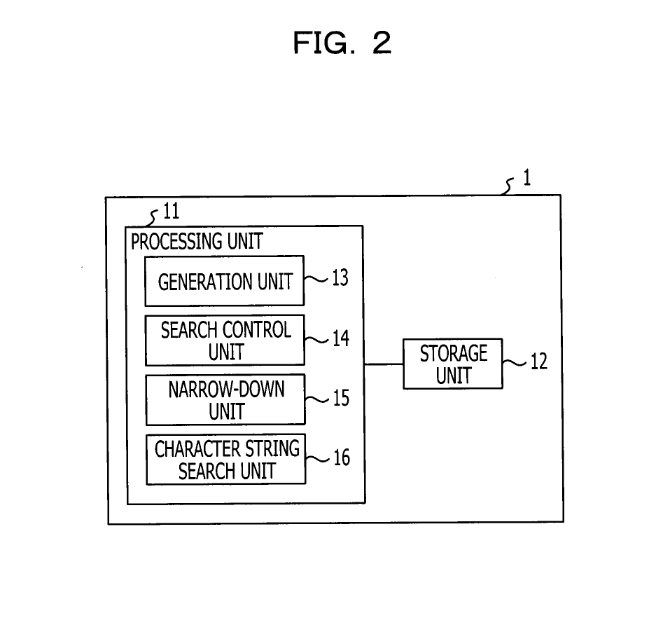

FIG. 2 illustrates the functional configuration of a computer 1 which executes the above-described processing of the embodiment. The computer 1 includes a processing unit 11 and a storage unit 12. The processing unit 11 generates index information and performs search using the generated index information. The storage unit 12 stores information which is used for the processing of the processing unit 11 (for example, a group of files F1 to Fn which are to be search objects, and index information).

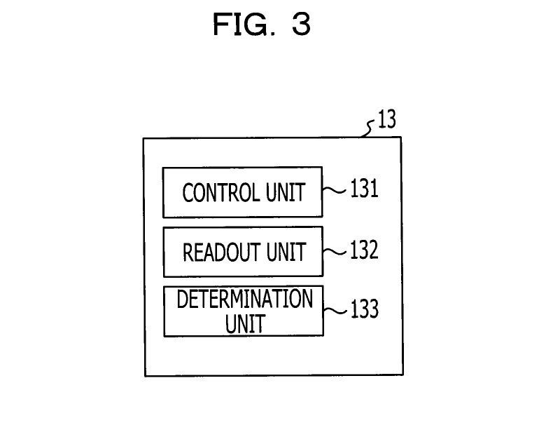

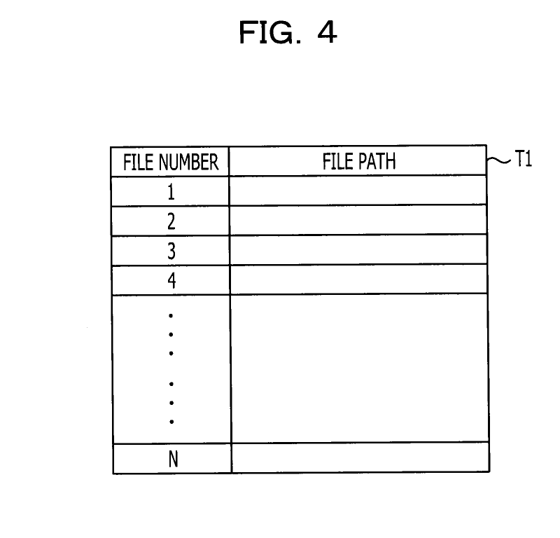

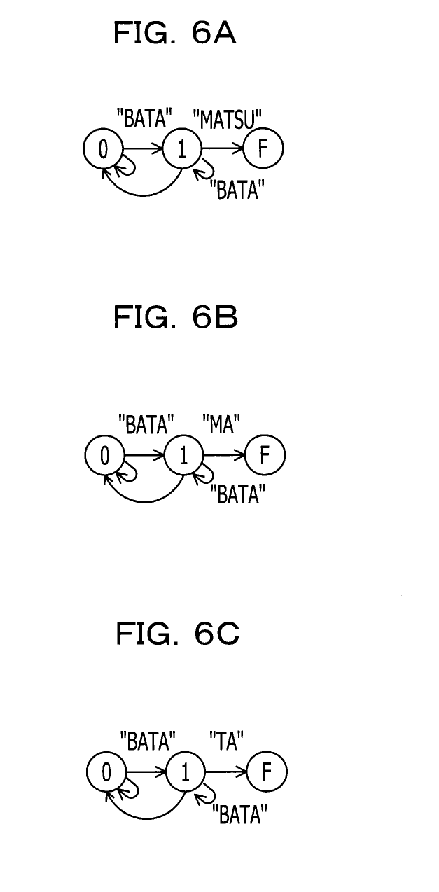

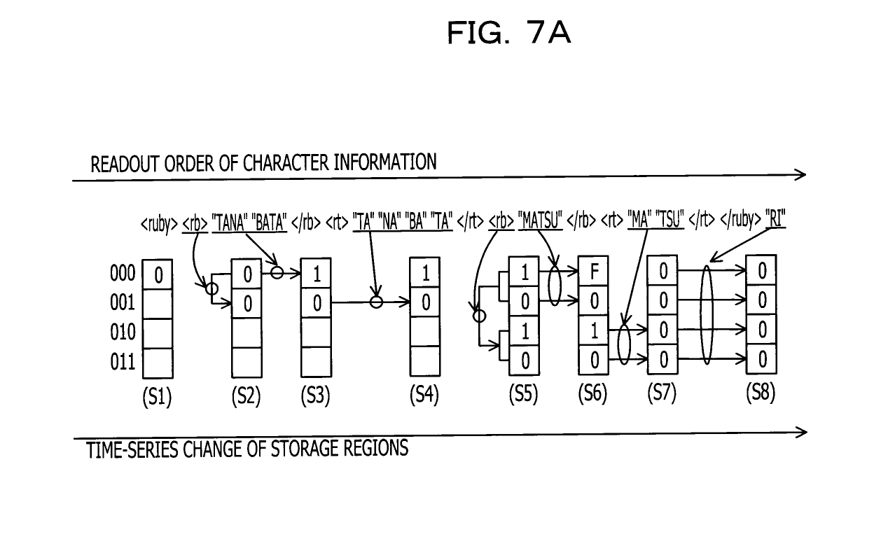

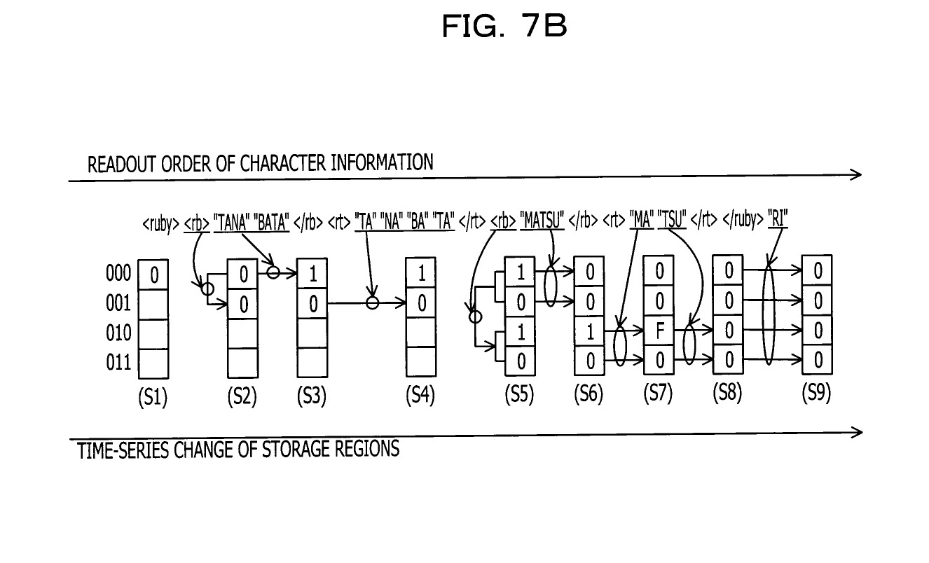

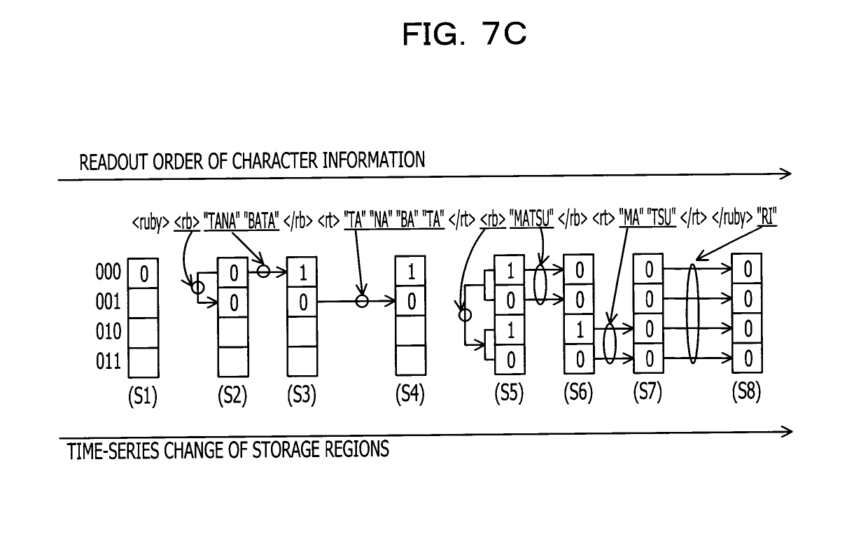

The processing unit 11 includes a generation unit 13. The generation unit 13 generates index information to store the index information in the storage unit 12. FIG. 3 illustrates an example of a function block of the generation unit 13. The generation unit 13 includes a control unit 131, a readout unit 132, and a determination unit 133. The control unit 131 secures storage regions in the storage unit 12 and sequentially designates files from the file Fl to file Fn so as to allow the readout unit 132 and the determination unit 133 to execute respective processing for the designated file. The readout unit 132 reads out the file Fi, which is designated by the control unit 131, in the group of files F1 to Fn from the storage unit 12. The determination unit 133 determines whether or not the file Fi includes character information Cj, for each piece of character information Cj of the group of character information C1 to Cm which are set. This determination processing will be described later with reference to FIGS. 6A to 6C and FIGS. 7A to 7C. When it is determined that the file Fi includes the character information Cj, the control unit 131 stores information indicating the inclusion of the character information Cj, in a storage region expressed by an address, which is calculated on the basis of the character information Cj and a file number i of the file Fi, among storage regions which are secured. FIG. 4 illustrates an example of a table T1 which stores an association relationship between a file number and a file path. When a file number is designated by the control unit 131, the readout unit 132 specifies a file which is to be a readout object on the basis of the designated file number and a file path which corresponds to the designated file number in the table T1.

As depicted in FIG. 2, the processing unit 11 further includes a search control unit 14, a narrow-down unit 15, and a character string search unit 16. The search control unit 14 controls the narrow-down unit 15 and the character string search unit 16 so as to perform search processing corresponding to a search request. The narrow-down unit 15 narrows down search object files by using index information which is generated by the generation unit 13. For example, the search control unit 14 extracts character information Ca from a search character string which is included in a received search request and notifies the narrow-down unit 15 of the extracted character information Ca. The narrow-down unit 15 notifies the search control unit 14 of a file number of a file other than a file which does not include character information Ca which is notified from the search control unit 14, among the group of files F1 to Fn. The narrow-down unit 15 reads outs a bit column corresponding to the character information Ca from the index information so as to notify the search control unit 14 of a file number corresponding to a bit having a value of “1”, for example. The search control unit 14 notifies the character string search unit 16 of a file number which is obtained through the narrowing down performed by the narrow-down unit 15. The character string search unit 16 performs character string search based on a search request which is received by the search control unit 14, with respect to a file which is notified from the search control unit 14.

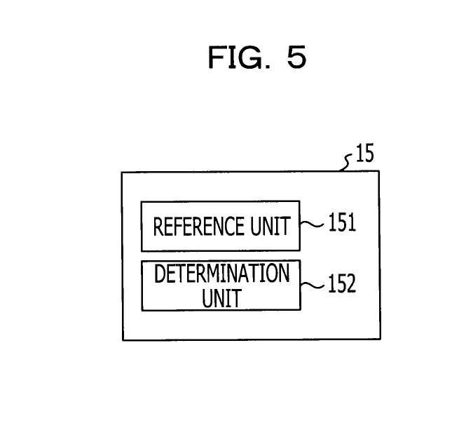

FIG. 5 illustrates an example of a function block of the narrow-down unit 15. The narrow-down unit 15 includes a reference unit 151 and a determination unit 152. The reference unit 151 reads out part corresponding to the character information Ca which is notified from the search control unit 14, from the index information which is stored in the storage unit 12. An address representing part corresponding to the character information Ca is obtained by substituting a binary code of the character information Ca into a hash function, for example. The determination unit 152 determines a file which does not include the character information Ca on the basis of a bit column which is read by the reference unit 151, so as to notify the character string search unit 16 of a file number of a file other than the file which does not include the character information Ca among the group of files F1 to Fn. For example, the determination unit 152 notifies the character string search unit 16 of a file number corresponding to a bit having a value of “1”, among bits which are included in a bit column.

The search control unit 14 may extract a plurality of pieces of character information (for example, character information Ca and character information Cb) from a search string. In this case, the reference unit 151 reads out a corresponding bit column from the index information for each of the plurality of pieces of character information Ca and Cb. Further, the determination unit 152 calculates a logical AND between existence/nonexistence information included in a bit column corresponding to the character information Ca and existence/nonexistence information included in a bit column corresponding to the character information Cb, so as to determine existence/nonexistence of the character information Ca and Cb in each file on the basis of the calculation result. A file number of a file which is determined such that the file do not include either one of the character information Ca and the character information Cb is not notified to the character string search unit 16.

Processing of the determination unit 133 for determining whether or not a file Fi includes character information Cj which is included in a group of character information C1 to Cm is now described.

FIGS. 6A to 6C respectively illustrate automatons which are generated on the basis of the character information Cj. An automaton expresses a condition of state transition in each state. Transition from a certain state to a state corresponding to a transition condition with which character information which is read out is accorded is performed in the certain state.

FIG. 6A illustrates an automaton which is generated on the basis of character information ““bata” “matsu””. The automaton depicted in FIG. 6A represents that when character information “bata” is read out from the file Fi in an initial state (0), transition from the initial state (0) to a state (1) is performed. Further, the automaton depicted in FIG. 6A represents that when character information other than the character information “bata” is read out in the initial state (0), transition to the initial state (0) is performed again. In a similar manner, the automaton depicted in FIG. 6A represents that, in the state (1), transition to a state (F) is performed when character information “matsu” is read out, and transition to the state (1) is performed when the character information “bata” is read out. Further, the automaton depicted in FIG. 6A represents that when character information other than the character information “bata” or “matsu” is read out in the state (1), transition to the initial state (0) is performed again. The state (F) indicates collation completion by the automaton. When the state of the automaton becomes to be the state (F), the determination unit 133 determines that a character string according with ““bata” “matsu”” exists in the file Fi.

FIG. 6B illustrates an automaton which is generated on the basis of character information ““bata” “ma””. The automaton depicted in FIG. 6B represents that when character information “bata” is read out from the file Fi in an initial state (0), transition from the initial state (0) to the state (1) is performed. Further, the automaton depicted in FIG. 6B represents that when character information other than the character information “bata” is read out in the initial state (0), transition to the initial state (0) is performed again. In a similar manner, the automaton depicted in FIG. 6B represents that, in the state (1), transition to the state (F) is performed when character information “ma” is read out, and transition to the state (1) is performed when the character information “bata” is read out. Further, the automaton depicted in FIG. 6B represents that when character information other than the character information “bata” or “ma” is read out in the state (1), transition to the initial state (0) is performed again. When the state of the automaton becomes to be the state (F), the determination unit 133 determines that a character string according with ““bata” “ma”” exists in the file Fi.

FIG. 6C illustrates an automaton which is generated on the basis of character information ““bata” “ta””. The automaton depicted in FIG. 6C represents that when character information “bata” is read out from the file Fi in an initial state (0), transition from the initial state (0) to the state (1) is performed. Further, the automaton depicted in FIG. 6C represents that when character information other than the character information “bata” is read out in the initial state (0), transition to the initial state (0) is performed again. In a similar manner, the automaton depicted in FIG. 6C represents that, in the state (1), transition to the state (F) is performed when character information “ta” is read out, and transition to the state (1) is performed when the character information “bata” is read out. Further, the automaton depicted in FIG. 6C represents that when character information other than the character information “bata” or “ta” is read out in the state (1), transition to the initial state (0) is performed again. When the state of the automaton becomes to be the state (F), the determination unit 133 determines that a character string according with ““bata” “ta”” exists in the file Fi.

FIG. 7A illustrates state change of the automaton depicted in FIG. 6A in the determination processing of the determination unit 133. Information indicating a state (state information) is stored in storage regions (000 to 011). The numbers 000 to 111 are binary numbers and are addresses indicating respective storage regions which are storage destinations of pieces of state information. FIG. 7A illustrates state information change in collation with the description D1 which is “<ruby> <rb>“tana” “bata”</rb> <rp>(</rp> <rt>“ta” “na” “ba” “ta”</rt> <rp>)</rp> <rb>“matsu”</rb> <rp>(</rp> <rt>“ma” “tsu”</rt> <rp>)</rp> </ruby>“ri”” which is included in the file Fi. Here, illustration of FIGS. 7A to 7C does not include <rp> tags.

It is assumed that state information before collation with the description D1 is such that the state (0) is merely stored in the storage region 000 (S1). When a <rb> tag is read out from the file Fi, the determination unit 133 copies the state information which is stored in the storage region 000 onto the storage region 001 (S2).

Subsequently, the determination unit 133 reads out “tana” from the file Fi and updates the state information which is stored in the storage region 000. The state which is stored in the storage region is the state (0) and is not accorded with a transition condition “bata”, so that the determination unit 133 sets the state information of the storage region 000 as the state (0). Then, the determination unit 133 reads out “bata” from the file Fi and updates the state information which is stored in the storage region 000. In this case, “bata” which is read from the file Fi is accorded with the transition condition in the state (0), so that the determination unit 133 updates the state information of the storage region 000 to the state (1) (S3).

When the determination unit 133 reads out a <rt> tag from the file Fi, the determination unit 133 shifts a storage region of an update object from the storage region 000 to the storage region 001. The determination unit 133 sequentially reads out character information “ta”, “na”, “ba”, and “ta” and updates the state information of the storage region 001. However, none of “ta”, “na”, “ba”, and “ta” is accorded with the transition condition “bata” in the initial state (0), so that the state information of the storage region 001 remains in the state (0) (S4).

When the determination unit 133 reads out a <rb> tag from the file Fi, the determination unit 133 further copies a storage region. The determination unit 133 copies the state information of the storage region 000 onto the storage region 010 and copies the state information of the storage region 001 onto the storage region 011 (S5).

Then, the determination unit 133 reads out “matsu” from the file Fi and updates the state information which is stored in the storage region 000. In this case, “matsu” which is read out from the file Fi is accorded with the transition condition in the state (1), so that the determination unit 133 updates the state information of the storage region 000 to the state (F). Further, the determination unit 133 updates the state information which is stored in the storage region 001, as well. The state which is stored in the storage region is the state “0” and is not accorded with the transition condition “bata”, so that the determination unit 133 sets the state information of the storage region 001 as the state (0) (S6). The state information of the state (F) is stored in the storage region at S6, so that the determination unit 133 determines that the file Fi includes the character information ““bata” “matsu””.

When the determination unit 133 reads out a <rt> tag from the file Fi, the determination unit 133 shifts a storage region of an update object from the storage region 000 and the storage region 001 to the storage region 010 and the storage region 011. The determination unit 133 sequentially reads out character information “ma” and “tsu” from the file Fi and updates state information of the storage region 010 and the storage region 011. However, neither “ma” nor “tsu” is accorded with the transition condition “bata” in the initial state (0), so that the state information of the storage region 010 and the state information of the storage region 011 remain in the state (0) (S7).

Further, when the determination unit 133 reads out a </ruby> tag from the file Fi, the determination unit 133 sets the storage regions 000 to 011 which store respective pieces of state information, as storage regions of update objects. The determination unit 133 reads out character information “ri” from the file Fi and updates the respective pieces of state information which are stored in the storage regions 000 to 011 (S8).

The determination unit 133 may stop the following determination processing based on the automaton of FIG. 6A at the transition to the state (F) as depicted in S6. This is because the transition to the state (F) represents that the file Fi obviously includes ““bata” “matsu””.

Duplication of state information corresponding to readout of a <rb> tag and shift of a storage region of an update object corresponding to readout of a <rt> tag are performed on the basis of the following addressing, for example. A storage region, which is a duplication destination, of state information is determined in accordance with a storage region which is a duplication source and multiplicity of the duplication, for example. For example, in the first duplication, a storage region having an address of which a value of the lowest digit is “0” is a duplication source and a storage region having an address of which a value of the lowest digit is “1” is a duplication destination. In the first duplication, state information which is stored in the storage region 000 is copied onto the storage region 001. After the first duplication, the determination unit 133 shifts an update object in accordance with a value of the lowest digit of an address. When character information inserted between <rb> tags is read out, state information which is stored in the storage region 000 having an address of which a value of the lowest digit is “0” is updated. When character information inserted between <rt> tags is read out, state information which is stored in the storage region 001 having an address of which a value of the lowest digit is “1” is updated.

When duplication is further performed (second duplication), state information of a storage region having an address of which a value of the second lowest digit is “0” (expressed by an address such as 000 and 001) is copied onto a storage region having an address of which a value of the second lowest digit is “1” (expressed by an address such as 010 and 011). After the second duplication, the determination unit 133 shifts an update object in accordance with the second lowest digit of an address. When character information inserted between <rb> tags is read out, state information which is stored in the storage region 000 and state information which is stored in the storage region 001 respectively having addresses of which values of the second lowest digit are “0” are updated. Further, when character information inserted between <rt> tags is read out, state information which is stored in the storage region 010 and state information which is stored in the storage region 011 respectively having addresses of which values of the second lowest digit are “1” are updated.

According to the above-described addressing, even though <rb> tags appear a plurality of times, shift of a storage region of an update object is enabled through update based on character information which is inserted between <rb> tags and update based on character information which is inserted between <rt> tags.

FIG. 7B illustrates change of a state of the automaton depicted in FIG. 6B in the determination processing of the determination unit 133. The automaton depicted in FIG. 6B is used for accord determination with character information ““bata” “ma”” as described above. FIG. 7B illustrates state information change in collation with the description D1 which is included in the file Fi as is the case with FIG. 7A. State information which is stored in storage regions 000 to 011 is changed in a similar manner to the state information change illustrated in FIG. 7A, from S1 to S5.

Then, the determination unit 133 reads out “matsu” from the file Fi and updates the state information which is stored in the storage region 000. In this case, “matsu” which is read out from the file Fi is not accorded with a transition condition “ma” in the state (1), so that the determination unit 133 updates the state information of the storage region 000 to the initial state (0). Further, the determination unit 133 updates the state information which is stored in the storage region 001, as well. The state which is stored in the storage region is the state “0” and is not accorded with a transition condition “bata”, so that the determination unit 133 sets the state information of the storage region 001 as the state (0) (S6).

When the determination unit 133 reads out a <rt> tag from the file Fi, the determination unit 133 shifts a storage region of an update object from the storage region 000 and the storage region 001 to the storage region 010 and the storage region 011 that have addresses of which the second lowest value is “1”. The determination unit 133 sequentially reads out character information “ma” from the file Fi and updates the state information of the storage region 010 and the storage region 011. The character information “ma” is accorded with a transition condition “ma” in the state (1), so that the determination unit 133 updates the state information of the storage region 010 to the state (F). Further, the character information “ma” is not accorded with the transition condition “bata” in the initial state (0), so that the state information of the storage region 011 remains in the state (0) (S7). The state information of the state (F) is stored in the storage region at S7, so that the determination unit 133 determines that the file Fi includes the character information ““bata” “ma””.

Then, the determination unit 133 reads out character information “tsu” from the file Fi and updates the state information which is stored in the storage region 010 and the state information which is stored in the storage region 011.

“tsu” is not accorded with the transition condition, so that the determination unit 133 updates the respective pieces of state information which are stored in the storage region 010 and the storage region 011 to the initial state (0) (S8).

Further, when the determination unit 133 reads out a </ruby> tag from the file Fi, the determination unit 133 sets the storage regions 000 to 011 which store respective pieces of state information as storage regions of update objects. The determination unit 133 reads out character information “ri” from the file Fi and updates the state information which is stored in each of the storage regions 000 to 011 (S9).

As described above, the determination unit 133 may stop the following determination processing based on the automaton of FIG. 6B at the transition to the state (F) as depicted in S7. This is because the transition to the state (F) represents that the file Fi obviously includes ““bata” “ma””.

FIG. 7C illustrates change of a state of the automaton depicted in FIG. 6C in the determination processing of the determination unit 133. The automaton depicted in FIG. 6C is used for accord determination with character information ““bata” “ta”” as described above. FIG. 7C illustrates state information change in collation with the description D1 which is included in the file Fi as is the case with FIG. 7B. State information which is stored in storage regions 000 to 011 is changed in a similar manner to the state information change illustrated in FIG. 7B, from S1 to S6.

When the determination unit 133 reads out a <rt> tag from the file Fi, the determination unit 133 shifts a storage region of an update object from the storage region 000 and the storage region 001 to the storage region 010 and the storage region 011 that have addresses of which the second lowest value is “1”. The determination unit 133 sequentially reads out character information “ma” and “tsu” from the file Fi and updates the state information of the storage region 010 and the state information of the storage region 011. However, neither “ma” nor “tsu” is accorded with the transition condition, so that the state information of the storage region 010 and the state information of the storage region 011 are set to the initial state (0) (S7).

Further, when the determination unit 133 reads out a </ruby> tag from the file Fi, the determination unit 133 sets the storage regions 000 to 011 which store respective pieces of state information as storage regions of update objects. The determination unit 133 reads out character information “ri” from the file Fi and updates the state information which is stored in each of the storage regions 000 to 011 to the initial state (0) (S8).

In FIGS. 7A to 7C, when the determination unit 133 reads out a </ruby> tag, for example, the determination unit 133 releases a storage region storing overlapped state information, among the storage regions 000 to 011. For example, in S8 of FIG. 7A, the storage region 001, the storage region 010, and the storage region 011 store respective pieces of state information which are overlapped with the state information of the storage region 000, being released. For example, when the storage region 001, the storage region 010, and the storage region 011 are released, update of state information based on the character information “ri” in the file Fi is performed only with respect to the state information which is stored in the storage region 000.

The determination procedure for determining whether or not the file Fi includes the character information Cj has been described with reference to FIGS. 6A to 6C and FIGS. 7A to 7C. The above-described example illustrates a case where parts in which provision of a plurality of types of notations are designated for a language unit which has one meaning are continued as ““tana” “bata” . . . “ta” “na” “ba” “ta” . . . “matsu” . . . “ma” “tsu” . . . “ri”” in document data. The parts provided with a plurality of notations are read as ““tana” “bata” “matsu” “ri””, ““ta” “na” “ba” “ta” “matsu” “ri””, ““tana” “bata” “ma” “tsu” “ri””, or ““ta” “na” “ba” “ta” “ma” “tsu” “ri”” on display. However, the document data includes ““tana” “bata” . . . “ta” “na” “ba” “ta” . . . “matsu” . . . “ma” “tsu” . . . “ri””, so that none of ““tana” “bata” “matsu” “ri””, ““ta” “na” “ba” “ta” “matsu” “ri””, ““tana” “bata” “ma” “tsu” “ri””, and ““ta” “na” “ba” “ta” “ma” “tsu” “ri”” is accorded with ““tana” “bata” . . . “ta” “na” “ba” “ta” . . . “matsu” . . . “ma” “tsu” . . . “ri””. In the above-described determination processing, it is determined that such character information (for example, ““bata” “ma””) is included that an end (for example, “bata”) of the character information ““tana” “bata”” which is a preceding part in which parent character notation is designated and a head (for example, “ma”) of the character information ““ma” “tsu” “ri”” which is a following part in which reading character notation is designated are provided in series, among continuing parts provided with a plurality of notations. Therefore, continuing character information such as ““tana” “bata” “ma” “tsu” “ri”” is collated and extracted even though character information such as ““ta” “na” “ba” “ta”” and “matsu” exists in between as ““tana” “bata” . . . “ta” “na” “ba” “ta” . . . “matsu” . . . “ma” “tsu” . . . “ri””. Regarding the above-described end and head, it is sufficient that character information which is the preceding part in which parent character notation is designated and character information which is the following part in which reading character notation is designated are continued. Thus, the number of characters is not limited.

According to one aspect of the embodiment, it is suppressed that a file including designation of provision of a plurality of notations in series is excluded from search objects of a search string which includes pieces of character information which are displayed in a continuing manner when displayed on the basis of the file.

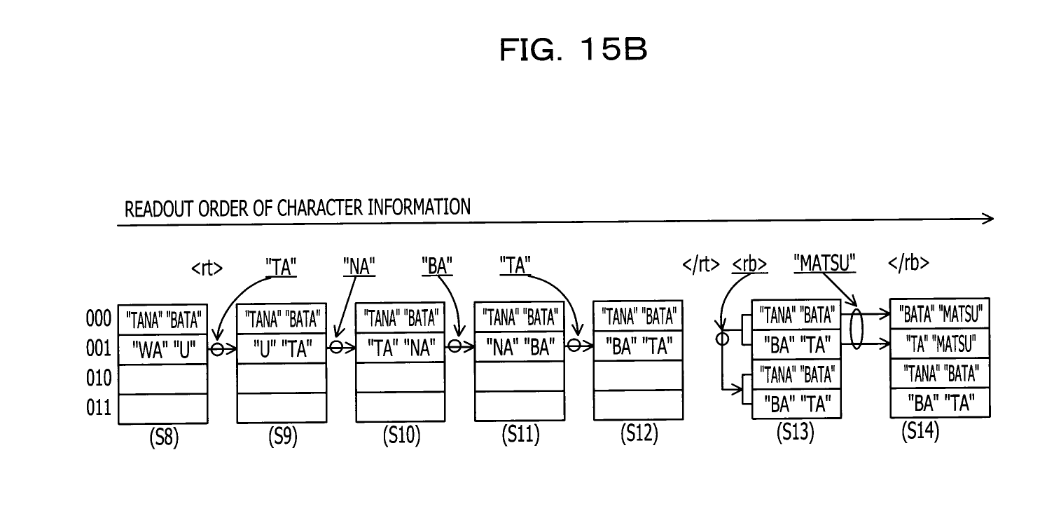

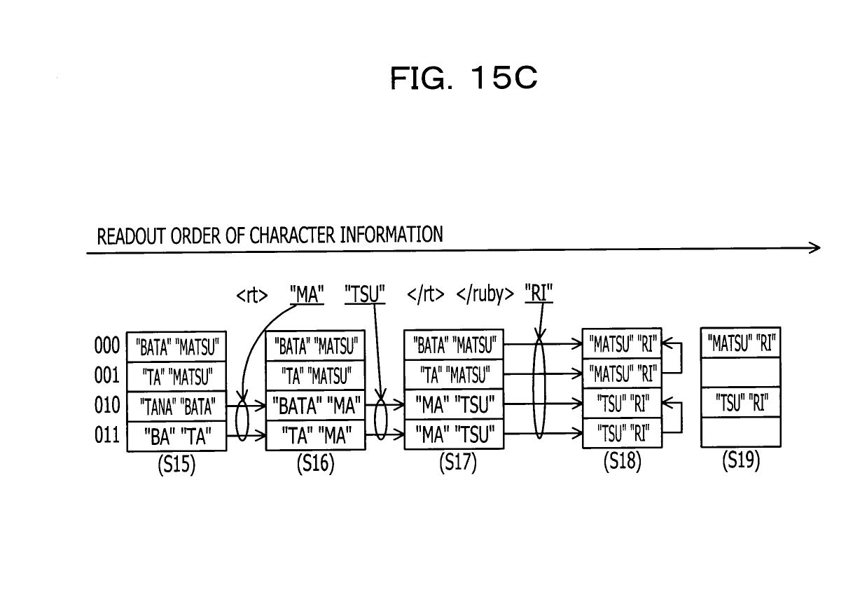

However, the determination procedure is not limited to this example. Any determination procedure may be employed as long as character information in which the notation 2 of the character information Cb (for example, “ma” of ““ma” “tsu””) follows the notation 1 of the character information Ca (for example, “bata” of ““tana” “bata””) (for example, ““bata” “ma””), or character information in which the notation 1 of the character information (for example, “matsu”) follows the notation 2 of the character information Ca (for example, “ta” of ““ta” “na” “ba” “ta””) (for example, ““ta” “matsu””) is extracted from the file Fi, in the procedure. Alternatively, such procedure may be employed that character information in which the notation 2 of the character information Ca (for example, “ta” of ““ta” “na” “ba” “ta””) follows the notation 1 of the character information Ca (for example, “bata” of ““tana” “bata””) (for example, ““bata” “ta””), or character information in which the notation 2 of the character information Cb (for example, “ma” of ““ma” “tsu””) follows the notation 1 of the character information Cb (for example, “matsu”) (for example, ““matsu” “ma””) is not extracted from the file Fi. Another index generation procedure which is different from the index generation procedure according to the determination illustrated in FIGS. 6A to 6C and FIGS. 7A to 7C will be described later in reference to FIGS. 15A to 15C.

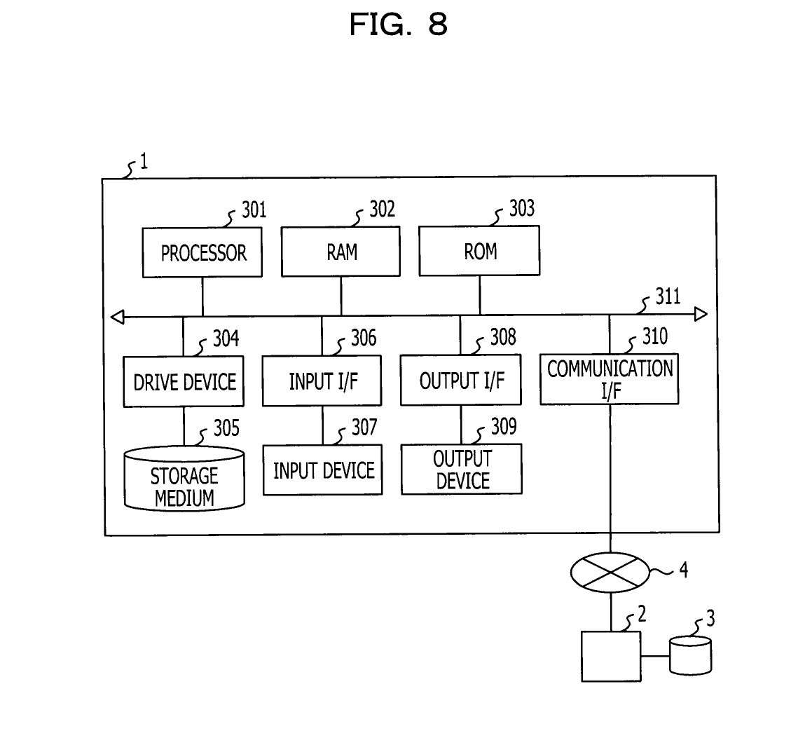

FIG. 8 illustrates the hardware configuration of the computer 1 and the configuration of a system including the computer 1. A system depicted in FIG. 8 includes the computer 1, a computer 2, a storage device 3, and a network 4. The group of files F1 to Fn is stored in the storage unit 12 of the computer 1, but the group of files F1 to Fn may be stored in the storage device 3 which is coupleed via the network 4, for example. In this case, the readout unit 132 reads out each of the group of files F1 to Fn not from the storage unit 12 but from the storage device 3.

Respective function blocks depicted in FIGS. 2, 3, and 5 are realized by the hardware configuration depicted in FIG. 8, for example. The computer 1 includes a processor 301, a random access memory (RAM) 302, a read only memory (ROM) 303, a drive device 304, a storage medium 305, an input interface (I/F) 306, an input device 307, an output interface (I/F) 308, an output device 309, a communication interface (I/F) 310, and a bus 311, for example. Respective hardware are coupleed with each other via the bus 311. The communication I/F 310 performs control of communication via the network 4. The input interface 306 is coupleed with the input device 307 and transmits an input signal which is received from the input device 307 to the processor 301. The output interface 308 is coupleed with the output device 309 and allows the output device 309 to execute output corresponding to an instruction of the processor 301.

The RAM 302 is a readable and writable memory device and is a semiconductor memory such as a static RAM (SRAM) and a dynamic RAM (DRAM), for example. Alternatively, a flash memory may be used instead of a RAM. The ROM 303 includes a programmable ROM (PROM) and the like, as well. The drive device 304 performs at least one of reading and writing of information which is stored in the storage medium 305. The storage medium 305 stores information which is written by the drive device 304. The storage medium 305 is a storage medium such as a hard disc, a compact disc (CD), a digital versatile disc (DVD), and a Blu-ray disc, for example. The computer 1 further includes a drive device 304 and a storage medium 305 for each of a plurality of types of storage media, for example.

The input device 307 transmits an input signal in accordance with an operation. The input device 307 is a key device such as a keyboard and a button which is attached to a body of the computer 1 and a pointing device such as a mouse and a touch panel, for example. The output device 309 outputs information in accordance with control of the computer 1. The output device 309 is an image output device (display device) such as a display, an audio output device such as a speaker, and the like, for example. Further, an input/output device such as a touch screen is used as the input device 307 and the output device 309, for example. Alternatively, the input device 307 and the output device 309 may not be included in the computer 1 but may be devices which are coupleed to the computer 1 from the outside, for example.

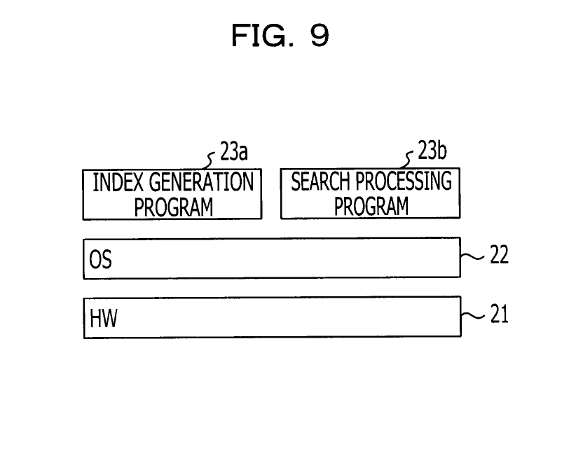

The processor 301 reads out a program which is stored in the ROM 303 and the storage medium 305 onto the RAM 302 and performs processing of the processing unit 11 in accordance with a procedure of the program which is read out. At this time, the RAM 302 is used as a work area of the processor 301. The function of the storage unit 12 is realized such that the ROM 303 and the storage medium 305 store a program and the group of files F1 to Fn and the RAM 302 is used as a work area of the processor 301. A program which is read out by the processor 301 is described with reference to FIG. 9.

FIG. 9 illustrates a configuration example of software which is operated in the computer 1. An operation system (OS) 22 which controls a hardware group 21 depicted in FIG. 9 is operated in the computer 1. The processor 301 operates in a procedure according to the OS 22 so as to control and administrate the hardware 21. Thus, processing by an application program and middleware is executed by the hardware 21. Further, in the computer 1, an index generation program 23a or a search processing program 23b is read out onto the RAM 302 so as to be executed by the processor 301. Further, the processor 301 performs processing based on the index generation program 23a (the processing is performed by controlling the hardware 21 in accordance with the OS 22), realizing the function of the generation unit 13. The processor 301 performs processing based on the search processing program 23b (the processing is performed by controlling the hardware 21 in accordance with the OS 22), realizing the functions of the search control unit 14, the narrow-down unit 15, and the character string search unit 16.

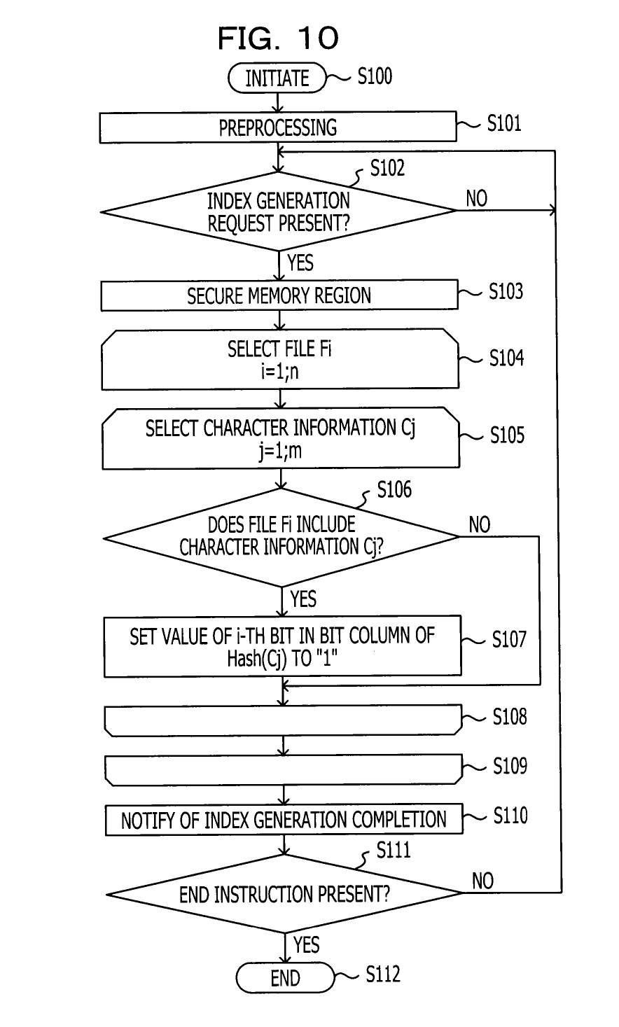

FIG. 10 illustrates a processing procedure example of index generation. When the index generation program 23a is initiated (S100), the control unit 131 performs preprocessing (S101). The preprocessing of S101 is processing of reading the table T1, which is depicted in FIG. 4, and the group of character information C1 to Cm onto the storage unit 12, for example. The control unit 131 determines whether or not generation of index information is requested (S102) and repeatedly performs the determination until generation of index information is requested (S102: NO). When generation of index information is requested (S102: YES), the control unit 131 secures a storage region for storing the index information (S103). For example, each bit in the storage region which is secured in S103 is set to “0”.

The control unit 131 selects a file number i from the table T1 depicted in FIG. 4 and allows the readout unit 132 to read out a file Fi having the file number i which is selected (S104). For example, the control unit 131 selects records of the table T1 in sequence in S104. Then, the determination unit 133 selects character information Cj which is one piece of character information of the character information C1 to Cm (S105). For example, the determination unit 133 may select character information in sequence from a list of the character information C1 to Cm which are held by the storage unit 12 or may increment a character code within a predetermined value range so as to generate character information in sequence, in S105. The determination unit 133 determines whether or not the file Fi includes the character information Cj (S106). In S106, the determination processing is performed in the procedure which is illustrated in FIGS. 7A to 7C. When the determination unit 133 determines that the file Fi includes the character information Cj (S106: YES), the control unit 131 calculates an address on the basis of the file number i and the character information Cj. The control unit 131 updates a bit on a position corresponding to the calculated address to “1”. That is, the control unit 131 stores a result of a logical add (OR) operation between the bit on the position corresponding to the calculated address and “1”, on a position corresponding to the calculated address. For example, the i-th bit in a bit column corresponding to a value which is obtained by substituting a binary code of the character information Cj into a predetermined hash function is set to “1”. When the control unit 131 updates a bit, the determination unit 133 performs processing of S108. When the determination unit 133 determines that the file Fi does not include the character information Cj (S106: NO), the determination unit 133 performs the processing of S108. Processing for following character information is performed. When there is unselected character information among the character information C1 to Cm, the determination unit 133 performs the processing of S105 again (S108). When there is no unselected character information in the character information C1 to Cm, processing of S109 is performed. In S109, when there is an unselected file in the group of files F1 to Fn, the readout unit 132 performs the processing of S104 again. When there is no unselected file in the group of files F1 to Fn, processing of S110 is performed.

The control unit 131 notifies that the generation processing of index information of the group of files F1 to Fn is completed (S110). In S110, the control unit 131 further stores information of the region which is secured in S103, as an index file. After the processing of S110, whether or not an end instruction has been received is determined (S111). When the end instruction has been received (S111: YES), the processing unit 11 ends the index generation program. When the end instruction has not been received (S111: NO), the processing of S102 is performed again.

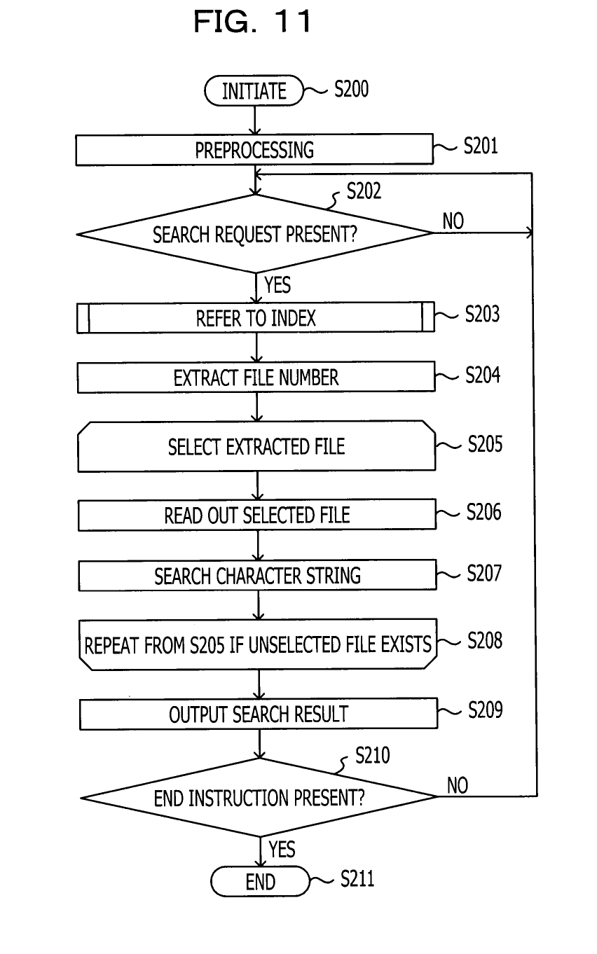

FIG. 11 illustrates a processing procedure example of full text search. When the search processing program 23b is initiated (S200), the search control unit 14 performs preprocessing (S201). The preprocessing of S201 is readout of the table T1, which is depicted in FIG. 4, and readout of index information. The search control unit 14 determines whether or not to have received a search request (S202) and repeatedly performs the determination until the search control unit 14 receives a search request (S202: NO). When the search control unit 14 has received a search request (S202: YES), index reference processing is executed (S203).

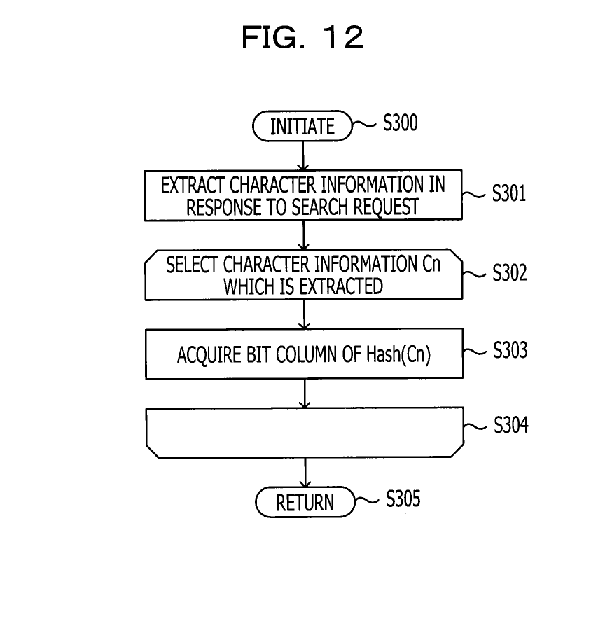

FIG. 12 illustrates an example of a reference processing procedure of index information. When S203 is executed (S300), the search control unit 14 takes out a search string which is included in a search request so as to extract character information Ca, Cb, . . . which are included in the search string among the character information C1 to Cm (S301).

When the search control unit 14 extracts the character information Ca, Cb, . . . , the narrow-down unit 15 determines whether or not each file of the group of files F1 to Fn is a file which does not includes any one piece of the extracted character information Ca, Cb, . . . . Specifically, one piece of character information among the pieces of character information which are extracted is selected (S302). The reference unit 151 calculates an address on the basis of the selected character information and reads out information which is stored on a position indicated by the calculated address (S303). In S303, the reference unit 151 calculates an address through an operation similar to that of S107. At that time, the reference unit 151 reads out a bit column corresponding to a value which is obtained by substituting a binary code of the selected character information into a predetermined hash function, for example. When there is unselected character information in the extracted character information Ca, Cb, . . . , the narrow-down unit 15 performs the processing of S302 again. When there is no unselected character information in the extracted character information Ca, Cb, . . . , the narrow-down unit 15 ends the index reference processing (S304, S305).

When the index reference processing is ended, the narrow-down unit 15 extracts a file number of a file which is a search object (S204). In S204, the determination unit 152 calculates a logical product (AND) between bit columns which are read out by the reference unit 151 for each piece of the character information Ca, Cb, . . . , for example. The determination unit 152 generates a number indicating an order of a bit having a value of “1” in the calculated bit column. For example, when the x-th bit and the y-th bit are “1” in a calculated bit column, the determination unit 152 generates x and y.

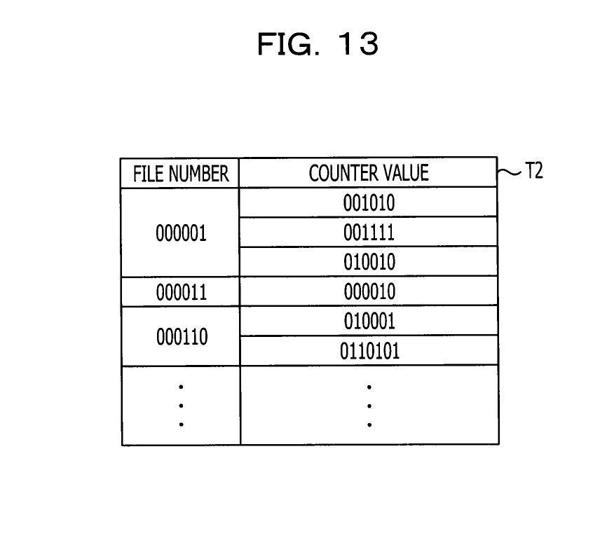

The search control unit 14 selects a number i which is any one of numbers x, y, . . . which are generated by the determination unit 152 (S205). The character string search unit 16 reads out a file Fi having a file number of i which is selected (S206). The character string search unit 16 reads out a file from a storage position corresponding to the file number i in the table T1 depicted in FIG. 4. The character string search unit 16 searches the file Fi which is read out, by the search string (S207). For example, when the character string search unit 16 detects a character string which is accorded with the search string in the file Fi, the character string search unit 16 generates information indicating a position, in the file Fi, of the accorded character string so as to store the information in the storage unit 12 in a manner to associate the information with the file number i of the file Fi (refer to FIG. 13). For example, a counter for counting an amount of data subjected to collation with a search string is prepared and a value of a counter in detection of accord with a character string is set to be information indicating a position in a file.

After the processing of S207, the search control unit 14 performs the processing of S205 when there is an unselected number among the numbers x, y, . . . which are generated by the determination unit 152. The search control unit 14 performs processing of S210 when there is no unselected number among the numbers x, y, . . . which are generated by the determination unit 152.

The search control unit 14 performs output processing of a search result (S209). For example, the search control unit 14 performs processing of extracting a character string adjacent to a position indicated by information which is stored in the table T2, which is depicted in FIG. 13, in the processing of S207 so as to display the extracted character string with a file name and the like corresponding to the file number on a display device.

After the processing of S210, the processing unit 11 determines whether or not an end instruction is given (S210). When no end instruction is given (S210: NO), the search control unit 14 performs the processing of 5202. When an end instruction is given (S210: YES), the processing unit 11 ends the search processing program 23b (S211).

FIG. 13 illustrates a list of positions of character information which is accorded with a search string. When there is character information which is accorded with a search string in the character string search of S207, the character string search unit 16 generates information indicating a position, in the file Fi, of the according character string and stores the information in the table T2 in a manner to associate the information with the file number i of the file Fi. The table T2 is referred when the search control unit 14 outputs a search result.

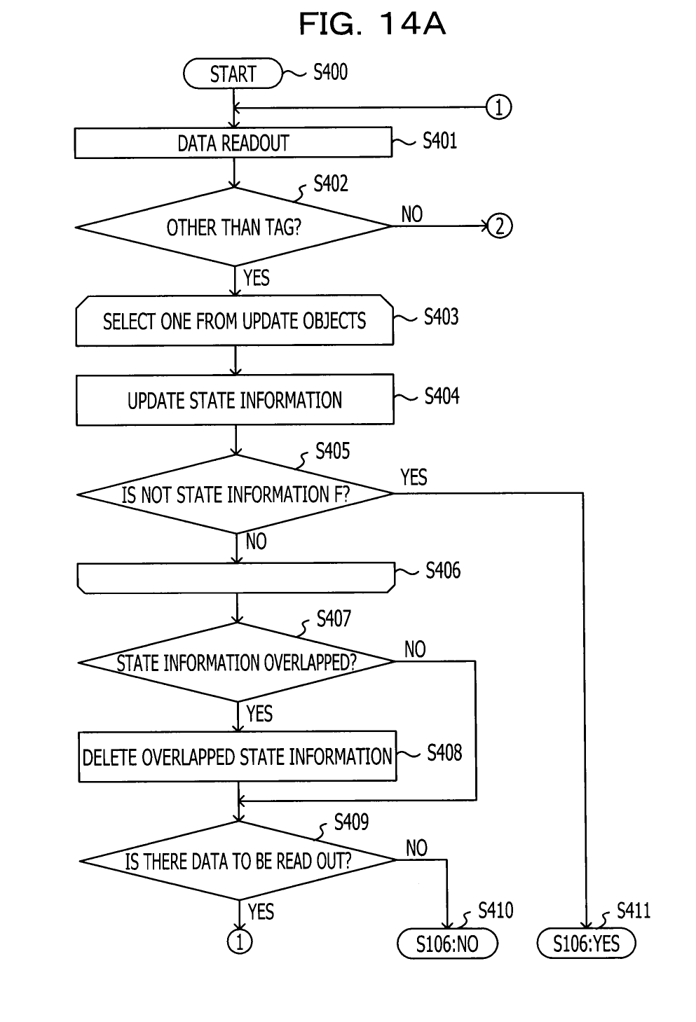

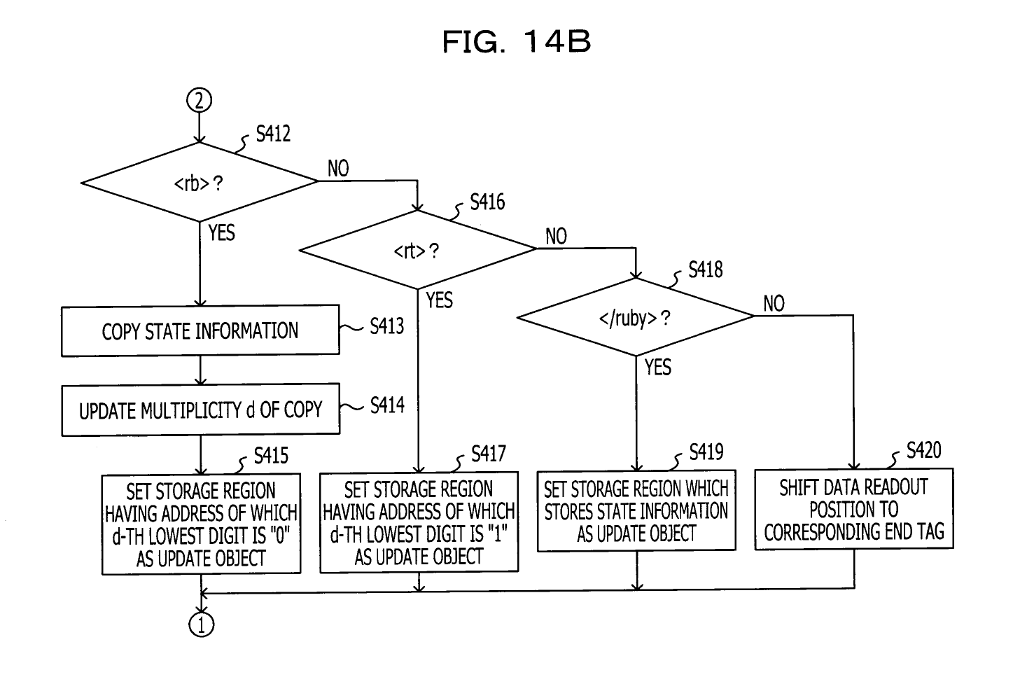

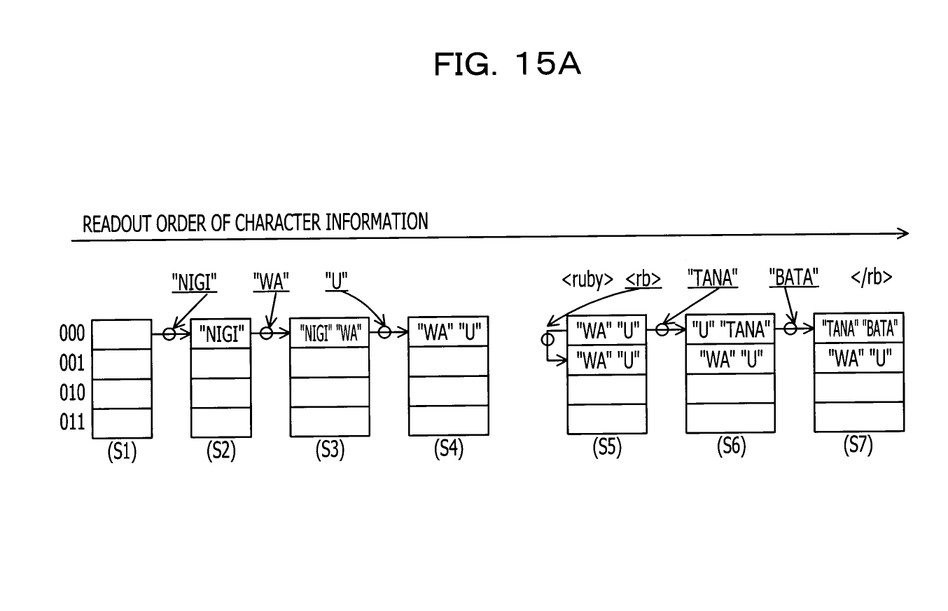

The procedure of the determination processing of S106 which is depicted in FIG. 10 is further described. FIG. 14A and FIG. 14B illustrate a processing procedure of 5106. When the determination processing is started (S400), the determination unit 133 reads out character information from the file Fi (S401). A data readout unit is a tag information unit, a character information unit for one character, or the like, for example. Then, the determination unit 133 determines whether or not data which is read out in S401 is other than tag information (S402).

When the character information which is read out in S401 is tag information (S402: NO), the determination unit 133 determines whether or not the tag information which is read out is a <rb> tag (S412). When the tag information which is read out is a <rb> tag (S412: YES), the determination unit 133 copies state information which is stored in a storage region (S413). An address of a duplication destination is specified in accordance with multiplicity d of duplication and an address of a duplication source, as described above. Further, the determination unit 133 updates the multiplicity d of duplication (S414). For example, an initial value of the multiplicity d of duplication is 0 and the multiplicity is incremented every time duplication is performed. The determination unit 133 confirms the duplication d and sets state information which is stored in a storage region having an address of which the d-th digit (d denotes multiplicity) is “0” among addresses of storage regions, as an update object (S415). That is, the state information of the duplication source in copying of S413 which is performed immediately before is set as an update object.

When the tag information which is read out is not a <rb> tag (S412: NO), the determination unit 133 determines whether or not the tag information which is read out is a <rt> tag (S416). When the tag information which is read out is a <rt> tag (S416: YES), the determination unit 133 confirms multiplicity d and sets state information which is stored in a storage region having an address of which the d-th digit (d denotes multiplicity) is “1” among addresses of storage regions, as an update object (S417).

When the tag information which is read out is not a <rt> tag (S416: NO), the determination unit 133 determines whether or not the tag information which is read out is a </ruby> tag (S418). When the tag information which is read out is a </ruby> tag (S418: YES), the determination unit 133 sets all pieces of state information which are stored in storage regions as update objects (S419). In S419, the determination unit 133 further sets a flag indicating deletion permission of overlapped state information. This flag is referred in S408 which will be described later. When the tag information which is read out is not a </ruby> tag (S418: NO), the determination unit 133 progresses a readout position of character information readout in S401 to an end tag corresponding to the tag which is read out (S420). When any one of S415, S417, S419, and S420 is performed, the character information readout processing of S401 is performed again.

When not tag information but character information is read out in S401 (S402: YES), the determination unit 133 selects one piece of state information from pieces of state information which are update objects (S403). At the collation processing start, state information which is an update object is the state information which is stored in the storage region 000. After state information is copied in the processing of S413, state information which is to be an update object is specified through S415, S417, or S420.

When the determination unit 133 selects state information in S403, the determination unit 133 performs collation processing for the character information which is read out, so as to update the state information which is selected (S404). This update is performed such that the determination unit 133 acquires a transition condition (defined by an automaton) of the selected state information, determines a transition destination state in accordance with whether or not the selected state information satisfies the acquired transition condition, and updates the selected state information to a transition destination state.

When the update of the state information is performed in S404, the determination unit 133 determines whether or not the state information which is updated in S404 indicates “F” (S405). “F” indicates a state of an end point of an automaton. When the state information is “F” in the determination of S405 (S405: YES), the determination unit 133 determines that the character information Cj is included in the file Fi in the determination processing of S106 (S106: YES) (S411).

When the state information is not “F” in the determination of S405 (S405: NO), the determination unit 133 determines whether or not there is unselected state information among pieces of state information which are update objects. When there is unselected state information, the collation unit 17 performs the processing of 5403 again to select unselected state information (S406). When there is no unselected state information, the determination unit 133 performs processing of S408.

The determination unit 133 determines whether there are a plurality of pieces of state information which indicate same state information in an overlapped manner, among pieces of state information which are stored in storage regions (S407). When there are a plurality of pieces of overlapped state information, the determination unit 133 confirms whether or not a flag indicating deletion permission of overlapped state information is set, through the processing of S419. When a flag indicating deletion permission is set, the determination unit 133 releases a storage region which stores the overlapped state information so as to exclude the state information from state information which is an update object (S408). Further, when the number of pieces of state information becomes to one through the processing of S408, the determination unit 133 clears the flag indicating deletion permission. When there is no overlapped state information in the processing of S407 (S407: NO) or when the processing of S408 is performed, the determination unit 133 determines whether or not there is character information which is to be read out from the file Fi (S409). When there is character information which is to be read out in the file Fi (S409: YES), the determination unit 133 performs the processing of S401 again. When there is no character information which is to be read out in the file Fi (S409: NO), the determination unit 133 ends the determination processing of S106 and determines that the character information Cj is not included in the file Fi (S106: NO) (S410).

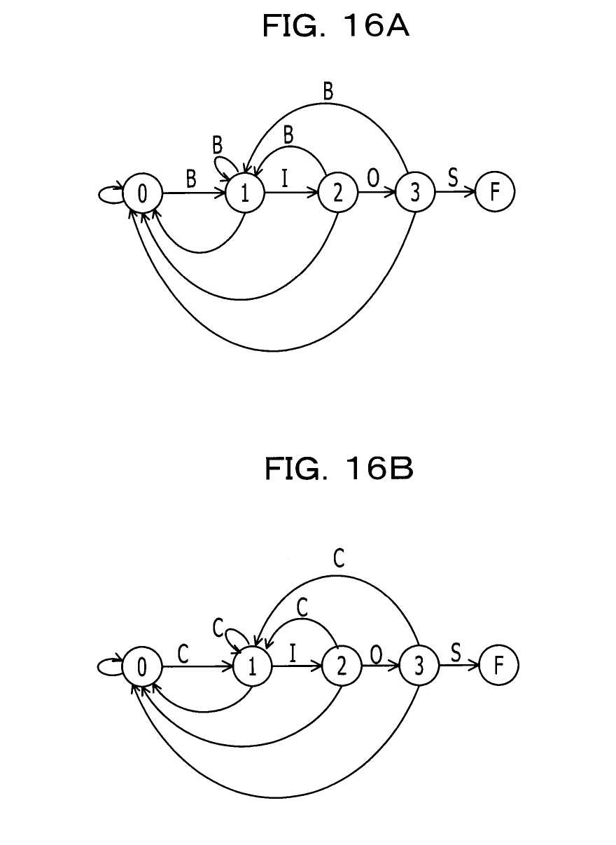

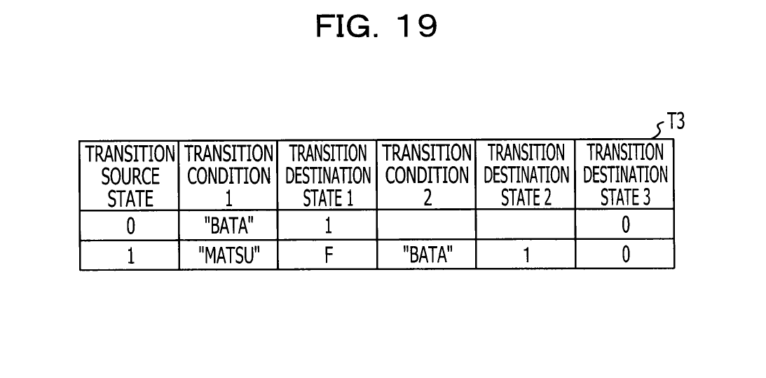

Determination processing using an automaton is further described. FIG. 19 illustrates a data configuration example of the automaton depicted in FIG. 6A. The similar data configurations are used for the automatons depicted in FIGS. 6B, 6C, 16A, and 16B. A table T3 depicted in FIG. 19 associates a combination between a transition condition 1 and a transition destination state 1, a combination between a transition condition 2 and a transition destination state 2, and a transition destination state 3 with each other for every transition source state which may arise. The determination unit 133 extracts a record including a transition source state which is accorded with state information which is stored in a storage region, from the table T3. Then, the determination unit 133 determines whether or not character information which is read out from the file Fi satisfies a transition condition included in the extracted record. When either the transition condition 1 or the transition condition 2 is satisfied, the determination unit 133 updates the state information to a transition destination state which is included in the extracted record and corresponds to the satisfied transition condition. When neither the transition condition 1 nor the transition condition 2 is satisfied, the determination unit 133 updates the state information to the transition destination state 3 which is included in the extracted record.

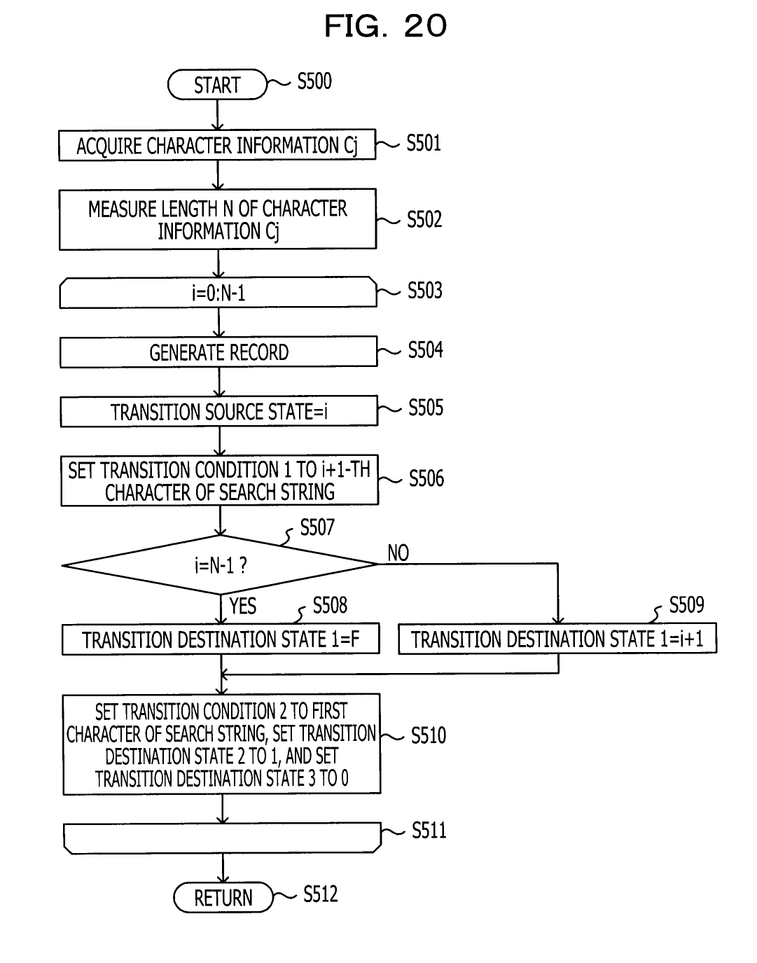

FIG. 20 illustrates a generation procedure example of an automaton. An automaton is used in index generation performed by the generation unit 13 and character string search performed by the character string search unit 16. The generation unit 13 generates an automaton for each piece of character information of the group of character information C1 to Cm in S101 depicted in FIG. 10, for example. Alternatively, when character information is selected in S105 depicted in FIG. 10, the generation unit 13 generates an automaton for the character information which is selected.

A flow depicted in FIG. 11 may be used in a case where a search string does not include a part, in which character information is repeated, like ““tana” “bata” “ma” “tsu” “ri””. For example, a character string such as ““de” “n” “de” “n” “mushi”” (each of “de”, “n”, “de”, and “n” expresses one Hiragana character and “mushi” expresses one Chinese character in the original specification) includes repetition of character information (““de” “n”” is repeated). When an automaton is generated with respect to the search string ““de” “n” “de” “n” “mushi””, a flow different from that in FIG. 11 is used. In a case where a character string such as “. . . “de” “n” “de” “n” “de” “n” “mushi” . . . ” is included in a collation object and the flow illustrated in FIG. 11 is used, the state is shifted up to ““de” “n” “de” “n”” and the following “de” is not accorded with “mushi”. Therefore, an automaton for returning the state to the initial state is generated. If the state is returned to the initial state, the rest of the character string which is ““de” “n” “mushi”” is not accorded with ““de” “n” “de” “n” “mushi””. From the above description, another flow may be used so as to deal with a search string which includes repetition of character information such as ““de” “n” “de” “n” “mushi””.

When generation processing of an automaton is started (S500), the generation unit 13 first acquires character information Cj from the group of character information C1 to Cm (S501). Then, the generation unit 13 counts the length N of the character information Cj which is acquired (S502). The generation unit 13 sequentially selects an integer i from 0 to N−1 and repeatedly performs processing from S504 to S510 (S503).

The generation unit 13 adds one record to the table T3 (S504). The generation unit 13 sets a transition source state of the record which is generated in S504 to the integer “i” which is selected in S503 (S505). Further, the generation unit 13 sets a transition condition 1 of the record which is generated in S504 to the i+1-th character of the search string which is acquired in S501 (S506).

Subsequently, the generation unit 13 determines whether or not the integer i is N−1 (S507). When the integer i is N−1 (S507: YES), a transition destination state 1 of the record which is generated in S504 is set to “F (information indicating collation completion)” (S508). When the integer i is not N−1 (S507: NO), the generation unit 13 sets the transition destination state 1 of the record which is generated in S504 to “i+1” (S509).

Further, the generation unit 13 sets a transition condition 2 of the record which is generated in S504 to the first character in the search string, sets a transition destination state 2 to 1, and sets a transition destination state 3 to “0” (S510). After the processing of S510, the generation unit 13 determines whether i is N−1 or not. When i is not N−1, the generation unit 13 selects a next integer in S503 and performs the processing from S504 to S510 (S511). When i is N−1, the generation unit 13 ends the automaton generation processing (S512).

Another index generation procedure which is different from the index generation procedure through determination illustrated in FIGS. 6A to 6C and FIGS. 7A to 7C is described. In the above-described index generation, the character information C1 to Cm are sequentially selected with respect to a certain file Fi and whether or not the selected character information Cj exists in the file Fi is determined so as to reflect the determination result to index information. That is, when it is determined that the character information Cj exists in the file Fi, a bit corresponding to the character information Cj and the file Fi is updated to “1”. In an index generation procedure illustrated in FIGS. 15A to 15C, character information is read out from the file Fi and a bit on a part corresponding to the character information which is read out, among storage regions which are secured for index information, is updated to “1” so as to generate index information.

In the other index information generation procedure, the determination unit 133 secures storage regions 000 to 011 and stores character information which is read out into each of the storage regions 000 to 011. In an example of FIGS. 15A to 15C, it is assumed that the generation unit 13 generates a bit column indicating whether or not character information for two characters is included in each file, for every piece of character information for two characters. Every time the determination unit 133 stores character information of two characters in each of the storage regions, the control unit 131 updates a value of a bit corresponding to the character information which is stored in each of the storage regions to “1”. Every time the determination unit 133 reads out a character, the determination unit 133 stores character information which is obtained by sliding character information which is previously stored in a storage region by the character information which is read out. A storage destination of the character information which is read out is controlled in accordance with readout of a <rb> tag, a <rt> tag, a </ruby> tag, or the like, for example.

FIGS. 15A to 15C illustrate index generation processing which is performed for a description D3 which is ““nigi” “wa” “u” “tana” “bata” “matsu” “ri”” (each of “nigi”, “tana”, “bata”, and “matsu” expresses one Chinese character and each of “wa”, “u”, and “ri” expresses one Hiragana character in the original specification) in a file Fi (reading is omitted). When the determination unit 133 reads out “nigi” from the file Fi in a state that storage regions store nothing (S1), the determination unit 133 stores “nigi” in the storage region 000 (S2). When the determination unit 133 further reads out “wa”, the determination unit 133 stores ““nigi” “wa”” in the storage region 000 (S3). The character information for two characters is thus stored in the storage region 000, so that the control unit 131 updates a value of the i-th bit in a bit column corresponding to the character information ““nigi” “wa”” to “1” in index information. In a similar manner, when the determination unit 133 reads out “u”, the determination unit 133 updates the storage region 000 to ““wa” “u”” (S4) and the control unit 131 updates the i-th bit in a bit column corresponding to ““wa” “u”” to “1”.

Subsequently, when the determination unit 133 reads out a <rb> tag, the determination unit 133 copies the character information which is stored in the storage region 000 onto the storage region 001 (S5). Multiplicity d of duplication becomes to 1 due to this copying. Tag information which is catalyst of copying and an address of a copying destination may be specified through a procedure similar to the procedure illustrated in FIGS. 7A to 7C. When the determination unit 133 reads out “tana”, the determination unit 133 stores ““u” “tana”” in the storage region 000 (S6). When the determination unit 133 reads out “bata”, the determination unit 133 stores ““tana” “bata”” in the storage region 000 (S7). Every time the determination unit 133 stores ““u” “tana”” and ““tana” “bata””, the control unit 131 updates a value of a corresponding bit in the index information to “1”.

When the determination unit 133 reads out a <rt> tag, the determination unit 133 shifts a storage region of an update object from the storage region 000 to the storage region 001 (S8). The determination unit 133 sequentially stores ““u” “ta”, ““ta” “na””, ““na” “ba””, and ““ba” “ta”” in the storage region 001 in response to respective readout of “ta”, “na”, “ba”, and “ta” (S9, S10, S11, S12). Every time the determination unit 133 sequentially stores ““u”, ta””, ““ta” “na””, ““na” “ba””, and ““ba” “ta”” in the storage region 001, the control unit 131 updates a value of a corresponding bit in the index information to “1”.

When the determination unit 133 reads out a <rb> tag, the determination unit 133 further copies a storage region (S13). Multiplicity d of duplication becomes to 2 due to this copying. When the determination unit 133 then reads out “matsu”, the determination unit 133 performs update processing with respect to a storage region having an address of which the d-th lowest value is “0”. The determination unit 133 stores ““bata” “matsu”” in the storage region 000 and stores ““ta” “matsu”” in the storage region 001 (S14). When the determination unit 133 stores ““bata” “matsu”” in the storage region 000, the control unit 131 updates a value of a corresponding bit in the index information to “1”. When the determination unit 133 stores ““ta” “matsu”” in the storage region 001, the control unit 131 updates a value of a corresponding bit in the index information to “1”.

The determination unit 133 reads out <rt> and shifts a storage region of an update object from a storage region having an address of which the d-th lowest value is “0” to a storage region having an address of which the d-th lowest value is “1” (S15). The determination unit 133 stores ““bata” “ma”” and ““ma” “tsu”” in the storage region 010 and stores ““ta” “ma”” and ““ma” “tsu”” in the storage region 011 in response to readout of each of “ma” and “tsu” (S16, S17). The control unit 131 updates a value of a corresponding bit in the index information to “1” in response to the writing of each of ““bata” “ma””, ““ma” “tsu””, and ““ta” “ma”” in the storage regions performed by the determination unit 133.

When the determination unit 133 reads out </ruby>, the determination unit 133 sets the storage regions 000 to 011 as storage regions of update objects. When the determination unit 133 further reads out “ri”, the determination unit 133 stores ““matsu” “ri”” in the storage region 000, stores ““matsu” “ri”” in the storage region 001, stores ““tsu” “ri”” in the storage region 010, and stores ““tsu” “ri”” in the storage region 011 (S18). The control unit 131 updates a value of a corresponding bit in the index information to “1” in response to the writing of ““matsu” “ri”” and ““tsu” “ri”” in the storage regions performed by the determination unit 133. The determination unit 133 deletes character information which is overlapped among the storage regions (S19).

““matsu” “ri”” which is stored in the storage region 001 and ““tsu” “ri”” which is stored in the storage region 011 are deleted.

Each piece of character information for two characters which is included in ““nigi” “wa” “u” “tana” “bata” “matsu” “ri”” (reading is omitted) in the file Fi is reflected to the index information through the above-described procedure depicted in FIGS. 15A to 15C.

An example in which reading with respect to Chinese characters is displayed has been described above, but the embodiment is not limited to this example. Reading may be provided with respect to Katakana characters by Hiragana characters and pinyin may be provided to notations of Chinese characters in Chinese language. Further, reading is used for English and the above-described example of the embodiment is applicable to English. For example, “BIOS” is expressed as the description D2 in the file Fi as described above. On the other hand, “BIOS”, “BASICINPUT/OUTPUTSYSTEM”, or “BASICIOSYSTEM”, for example, may be inputted as a search string.

When a search string is “BIOS”, files which are objects of character string search are narrowed down on the basis of a bit column corresponding to “BIOS” in index information, for example. When a search string is “BASICIOSYSTEM”, for example, files which are objects of character string search are narrowed down on the basis of a bit column corresponding to each of “BASI”, “ASIC”, “ICIO”, “CIOS”, . . . , and “STEM” in the index information, for example.

FIG. 16A illustrates an automaton which is used for determination of whether or not character information “BIOS” is included in a file. A transition condition 1 (a corresponding transition destination state 1 is “1”) in an initial state (0) is “B”. A transition condition 1 (a corresponding transition destination state is “2”) in a state (1) is “I” and a transition condition 2 (a corresponding transition destination state 2 is “1”) is “B”. A transition condition 1 (a corresponding transition destination state is “3”) in a state (2) is “0” and a transition condition 2 (a corresponding transition destination state 2 is “1”) is “B”. A transition condition 1 (a corresponding transition destination state is “F”) in a state (3) is “S” and a transition condition 2 (a corresponding transition destination state 2 is “1”) is “B”.

FIG. 16B illustrates an automaton which is used for determination of whether or not character information “CIOS” is included in a file. A transition condition 1 (a corresponding transition destination state is “1”) in an initial state (0) is “C”. A transition condition 1 (a corresponding transition destination state is “2”) in a state (1) is “I” and a transition condition 2 (a corresponding transition destination state 2 is “1”) is “C”. A transition condition 1 (a corresponding transition destination state is “3”) in a state (2) is “0” and a transition condition 2 (a corresponding transition destination state 2 is “1”) is “C”. A transition condition 1 (a corresponding transition destination state is “F”) in a state (3) is “S” and a transition condition 2 (a corresponding transition destination state 2 is “1”) is “C”.

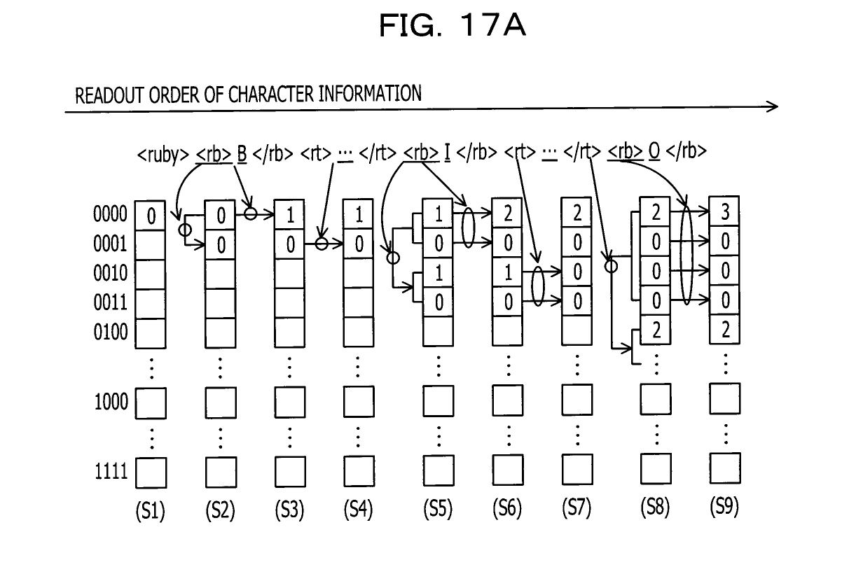

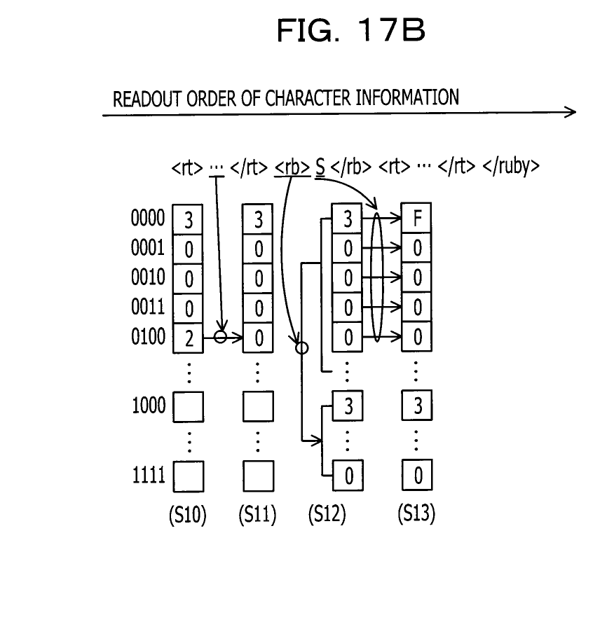

FIGS. 17A and 17B illustrate a determination procedure of whether or not “BIOS” is included in the description D2 in a file Fi. The determination unit 133 updates state information which is stored in a storage region on the basis of the automaton depicted in FIG. 16A.

It is assumed that only state information indicating an initial state (0) is stored in a storage region 0000 before readout of the description D2 (S1). When the determination unit 133 reads out a <rb> tag from the file Fi, the determination unit 133 copies the state information which is stored in the storage region 0000 onto a storage region 0001 (S2). Here, the determination unit 133 sets multiplicity d to “1”. Subsequently, when the determination unit 133 reads out “B”, the determination unit 133 updates the state information which is stored in the storage region 0000 in accordance with the automaton depicted in FIG. 16A. A condition of transition from the initial state (0) to the state (1) is “B”, so that state information which is to be stored in the storage region 0000 is the state (1) (S3). When the determination unit 133 reads out <rt>, the determination unit 133 shifts a storage region of an update object to 0001. The determination unit 133 updates the state information which is stored in the storage region 0001 in response to readout of each of “B”, “A”, “S”, “I”, and “C”. As a result, the state information of the storage region 0001 is updated to the initial state (0) (S4).

When the determination unit 133 reads out a <rb> tag from the file Fi, the determination unit 133 copies the state information which is stored in the storage region 0000 and the state information which is stored in the storage region 0001 respectively onto a storage region 0010 and a storage region 0011 (S5). Here, the determination unit 133 sets multiplicity d to “2”. Subsequently, when the determination unit 133 reads out “I”, the determination unit 133 updates the state information which is stored in the storage region 0000 in accordance with the automaton depicted in FIG. 16A. A condition of transition from the state (1) to the state (2) is “I”, so that state information which is to be stored in the storage region 0000 is the state (2). Further, a condition of transition from the initial state (0) to the state (1) is “B”, so that state information which is to be stored in the storage region 0001 is the initial state (0) (S6). When the determination unit 133 reads out <rt>, the determination unit 133 shifts a storage region of an update object to the storage region 0010 and the storage region 0011. The determination unit 133 updates the state information which is stored in the storage region 0010 and the state information which is stored in the storage region 0011 in response to readout of each of “I”, “N”, “P”, “U”, “T”, and “/”. As a result, the state information of the storage region 0010 and the state information of the storage region 0011 are updated to the initial state (0) (S7).

When the determination unit 133 reads out a <rb> tag from the file Fi, the determination unit 133 copies the pieces of state information which are stored in the storage regions 0000 to 0011 respectively onto storage regions 0100 to 0111 (S8). Here, the determination unit 133 sets multiplicity d to “3”. Subsequently, when the determination unit 133 reads out “0”, the determination unit 133 updates the state information which is stored in the storage region 0000 in accordance with the automaton depicted in FIG. 16A. A condition of transition from the state (2) to the state (3) is “0”, so that state information which is to be stored in the storage region 0000 is the state (3). Further, a condition of transition from the initial state (0) to the state (1) is “B”, so that pieces of state information which are to be stored respectively in the storage regions 0001 to 0011 are the initial state (0) (S9). When the determination unit 133 reads out <rt>, the determination unit 133 shifts a storage region of an update object to the storage regions 0100 to 0111 (S10). The determination unit 133 updates the pieces of state information which are stored in the storage regions 0100 to 0111 in response to readout of each of “O”, “U”, “T”, “P”, “U”, and “T”. As a result, the pieces of state information of the storage regions 0100 to 0111 are updated to the initial state (0) (S11).

When the determination unit 133 reads out a <rb> tag from the file Fi, the determination unit 133 copies the pieces of state information which are stored in the storage regions 0000 to 0111 respectively onto storage regions 1000 to 1111 (S12). Here, the determination unit 133 sets multiplicity d to “4”. Subsequently, when the determination unit 133 reads out “5”, the determination unit 133 updates the state information which is stored in the storage region 0000 in accordance with the automaton depicted in FIG. 16A. A condition of transition from the state (3) to the state (F) is “S”, so that state information which is to be stored in the storage region 0000 is the state (F). Further, a condition of transition from the initial state (0) to the state (1) is “B”, so that pieces of state information which are to be stored respectively in the storage regions 0001 to 0111 are the initial state (0) (S13). The state information which is stored in the storage region 0000 indicates the state (F), so that the determination unit 133 determines that the file Fi includes “BIOS”.

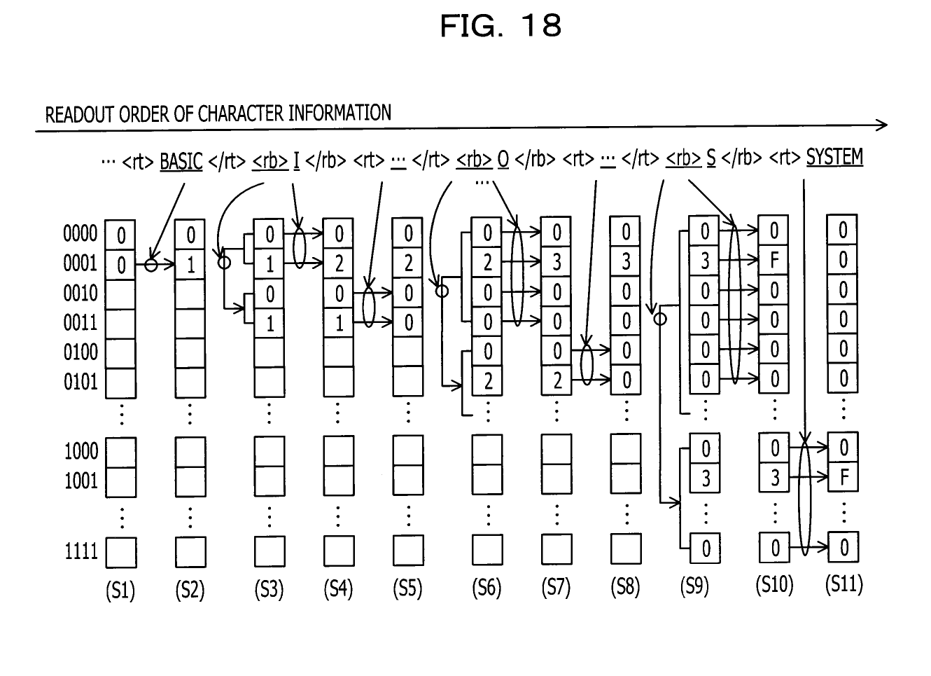

FIG. 18 illustrates a determination procedure of whether or not “CIOS” is included in the description D2 in the file Fi. The determination unit 133 updates state information which is stored in a storage region on the basis of the automaton depicted in FIG. 16B.

The determination unit 133 copies the state information which is stored in the storage region 0000 onto the storage region 0001 in response to readout of a <rb> tag from the file Fi (S1). Here, the determination unit 133 sets multiplicity d to “1”. Subsequently, when the determination unit 133 sequentially reads out “B”, “A”, “S”, “I”, and “C”, the determination unit 133 updates the state information which is stored in the storage region 0001 in accordance with the automaton depicted in FIG. 16B. A condition of transition from the initial state (0) to the state (1) is “C”, so that the state information which is to be stored in the storage region 0001 is the state (1) (S2).

When the determination unit 133 reads out a <rb> tag from the file Fi, the determination unit 133 copies the state information which is stored in the storage region 0000 and the state information which is stored in the storage region 0001 respectively onto a storage region 0010 and a storage region 0011 (S3). Here, the determination unit 133 sets multiplicity d to “2”. Subsequently, when the determination unit 133 reads out “I”, the determination unit 133 updates the state information which is stored in the storage region 0000 and the state information which is stored in the storage region 0001 in accordance with the automaton depicted in FIG. 16B. A condition of transition from the state (1) to the state (2) is “I”, so that state information which is to be stored in the storage region 0001 is the state (2). Further, a condition of transition from the initial state (0) to the state (1) is “C”, so that state information which is to be stored in the storage region 0000 is the initial state (0) (S4). When the determination unit 133 reads out <rt>, the determination unit 133 shifts a storage region of an update object to the storage region 0010 and the storage region 0011. The determination unit 133 updates the state information which is stored in the storage region 0010 and the state information which is stored in the storage region 0011 in response to readout of each of “I”, “N”, “P”, “U”, “T”, and “/”. As a result, the state information of the storage region 0010 and the state information of the storage region 0011 are updated to the initial state (0) (S5).

When the determination unit 133 reads out a <rb> tag from the file Fi, the determination unit 133 copies the pieces of state information which are stored in the storage regions 0000 to 0011 respectively onto storage regions 0100 to 0111 (S6). Here, the determination unit 133 sets multiplicity d to “3”. Subsequently, when the determination unit 133 reads out “O”, the determination unit 133 updates the pieces of state information which are stored in the storage regions 0000 to 0011 in accordance with the automaton depicted in FIG. 16B. A condition of transition from the state (2) to the state (3) is “O”, so that state information which is to be stored in the storage region 0001 is the state (3). Further, a condition of transition from the initial state (0) to the state (1) is “C”, so that pieces of state information which are to be stored respectively in the storage regions 0000, 0010, and 0011 are the initial state (0) (S7). When the determination unit 133 reads out <rt>, the determination unit 133 shifts a storage region of an update object to the storage regions 0100 to 0111. The determination unit 133 updates the pieces of state information which are stored in the storage regions 0100 to 0111 in response to readout of each of “O”, “U”, “T”, “P”, “U”, and “T”. As a result, the pieces of state information of the storage regions 0100 to 0111 are updated to the initial state (0) (S8).

When the determination unit 133 reads out a <rb> tag from the file Fi, the determination unit 133 copies the pieces of state information which are stored in the storage regions 0000 to 0111 respectively onto storage regions 1000 to 1111 (S9). Here, the determination unit 133 sets multiplicity d to “4”. Subsequently, when the determination unit 133 reads out “S”, the determination unit 133 updates the pieces of state information which are stored in the storage region 0000 to 0111 in accordance with the automaton depicted in FIG. 16B. A condition of transition from the state (3) to the state (F) is “S”, so that state information which is to be stored in the storage region 0001 is the state (F). Further, a condition of transition from the initial state (0) to the state (1) is “C”, so that pieces of state information which are to be stored respectively in the storage regions 0000, and 0010 to 0111 are the initial state (0) (S10). The state information which is stored in the storage region 0001 indicates the state (F), so that the determination unit 133 determines that the file Fi includes “CIOS”.

In a case where the determination unit 133 continues the determination processing, the determination unit 133 shifts a storage region of an update object to storage regions 1000 to 1111 when reading out <rt>. The determination unit 133 updates the pieces of state information which are stored in the storage regions 1000 to 1111 in response to readout of “S”. A condition of transition from the state (3) to the state (F) is “S”, so that state information which is to be stored in the storage region 1001 is the state (F). Further, a condition of transition from the initial state (0) to the state (1) is “C”, so that pieces of state information which are to be stored respectively in the storage regions 1000, and 1010 to 1111 are the initial state (0) (S11).

Application of the above-described embodiment enables extraction of the file Fi as character information which is accorded with a search string in any cases where the search string is “BIOS”, “BASICINPUT/OUTPUTSYSTEM”, or “BASICIOSYSTEM”.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A generation apparatus comprising:
a processor configured to:
generate existence information indicating that character information including a plurality of continuing characters is included in the file; and
in a case that first adscript designation and second adscript designation following to the first adscript designation are included in the file, the first adscript designation designating that first character information is written down with second character information, the second adscript designation designating that third character information is written down with fourth character information, generate another existence information indicating that another character information, which includes an end part of the first character information and a head part of the fourth character information following the end part, is included in the file.

2. The generation apparatus according to claim 1, wherein
the first character information is a first notation of a certain language unit,
the second character information is a second notation of the certain language unit,
the third character information is the first notation of another language unit, and
the fourth character information is the second notation of the another language unit.

3. The generation apparatus according to claim 1, wherein
the second character information is following the first character information in the file, and
the fourth character information is following the third character information in the file.

4. The generation apparatus according to claim 1, wherein
the existence information does not indicate that character information, including the end part of the first character information and a head part of the second character information following the end part of the first character information, is included in the file.

5. The generation apparatus according to claim 1, wherein
the another existence information further indicates that character information, including an end part of the second character information and a head part of the third character information following the end part of the second character information, is included in the file, and indicates that character information, including an end part of the fourth character information and a head part of the fifth character information following the second designation, is included in the file.

6. The generation apparatus according to claim 1, wherein
the second character information is displayed as ruby annotation of the first character information.

7. A generation method comprising:
generating existence information indicating that character information including a plurality of continuing characters is included in the file; and
in a case that first adscript designation and second adscript designation following to the first adscript designation are included in the file, the first adscript designation designating that first character information is written down with second character information, the second adscript designation designating that third character information is written down with fourth character information, generating another existence information indicating that another character information, which includes an end part of the first character information and a head part of the fourth character information following the end part, is included in the file, by a processor.

8. A computer-readable recording medium storing a generation program that causes a computer to execute:
generating existence information indicating that character information including a plurality of continuing characters is included in the file; and
in a case that first adscript designation and second adscript designation following to the first adscript designation are included in the file, the first adscript designation designating that first character information is written down with second character information, the second adscript designation designating that third character information is written down with fourth character information, generating another existence information indicating that character information, which includes an end part of the first character information and a head part of the fourth character information following the end part, is included in the file.

9. A searching apparatus comprising:
a memory configured to store existence information indicating that character information, which includes an end part of first character information and a head part of second character information following the end part, is included in a file, the existence information generated based on the file including first adscript designation and second adscript designation following the first designation, the first adscript designation designating that the first character information is written down with third character information, the second adscript designation designating that fourth character information is written down with the second character information; and
a processor configured to:
extract character information included in a search string; and
in the case that the existence information stored in memory corresponds to the extracted character, search the file for the search string.

10. The searching apparatus according to claim 9, wherein
the first character information is a first notation of a certain language unit,
the third character information is a second notation of the certain language unit,
the fourth character information is the first notation of another language unit, and
the second character information is the second notation of the another language unit.

11. The searching apparatus according to claim 9, wherein
the third character information is following the first character information in the file, and
the second character information is following the fourth character information in the file.

12. The searching apparatus according to claim 9, wherein
the existence information does not indicate that character information, including the end part of the first character information and a head part of the third character information following the end part of the first character information, is included in the file, in a case that the first adscript designation is included in the file.

13. The searching apparatus according to claim 9, wherein
the existence information further indicates that character information, including an end part of the third character information and a head part of the fourth character information following the end part of the third character information, is included in the file, and indicates that character information, including an end part of the second character information and a head part of the fifth character information following the second designation, is included in the file, in a case that the first adscript designation and the second adscript designation following to the first adscript designation are included in the file .

14. The searching apparatus according to claim 9, wherein
the third character information is displayed as ruby annotation of the first character information.

15. A searching method comprising:
extracting character information included in a search string;
obtaining, by a processor, existence information corresponding to the extracted character information and indicating that character information, which includes an end part of first character information and a head part of second character information following the end part, is included in a file, the existence information generated based on the file including first adscript designation and second adscript designation following the first designation, the first adscript designation designating that the first character information is written down with third character information, the second adscript designation designating that fourth character information is written down with the second character information; and
in the case of obtaining the existence information, searching the file for the search string.

16. A computer-readable recording medium storing a searching program that causes a computer to execute:
extracting character information included in a search string;
obtaining existence information corresponding to the extracted character information and indicating that character information, which includes an end part of first character information and a head part of second character information following the end part, is included in a file, the existence information generated based on the file including first adscript designation and second adscript designation following the first designation, the first adscript designation designating that the first character information is written down with third character information, the second adscript designation designating that fourth character information is written down with the second character information; and
in the case of obtaining the existence information, searching the file for the search string.
